(19) United States
(12) Patent Application Publication
(10) Pub. No.: US 2014/0154454 A1
(43) Pub. Date: Jun. 5, 2014

(54) Heat Resistant Seal Member

(71) Applicants: Shinshu University, Matsumoto-shi (JP); Schlumberger Technology Corporation, Sugar Land, TX (US)

(72) Inventors: Hiroyuki Ueki, Uedad-shi (JP); Toru Noguchi, Matsumoto-shi (JP); Masaei Ito, Sagamihara-shi (JP)

(73) Assignees: Shinshu University, Matsumoto-shi (JP); Schlumberger Technology Corporation, Sugar Land, TX (US)

(21) Appl. No.: 14/094,787

(22) Filed: Dec. 2, 2013

(30) Foreign Application Priority Data
Dec. 4, 2012 (JP) 2012-265514

(51) Int. Cl. C08K 3/04; F16J 9/26

(52) U.S. Cl. CPC C08K 3/04; F16J 9/26; Y10S 977/773; Y10S 977/762
USPC 428/66.4; 524/496; 524/495; 977/773; 977/762

(57) ABSTRACT

The heat resistant seal member according to one aspect of the present disclosure contains, for 100 parts by weight of a ternary fluoroelastomer, 5 to 15 parts by weight of first carbon nanofibers, 10 to 15 parts by weight of second carbon nanofibers, and 0 to 20 parts by weight of carbon black. The total amount of the first carbon nanofibers and the second carbon nanofibers are 15 to 30 parts by weight, and the total amount of the first carbon nanofibers, the second nanofibers, and the carbon black is 20 to 45 parts by weight. The heat resistant seal member can achieve a compression set of not more than 40% after 70 hours and 25% compressibility in a hydrogen sulfide gas atmosphere at 200° C.

### CROSS-REFERENCE TO RELATED APPLICATION

This application is based upon and claims the benefit of priority from Japanese Patent Application No. 2012-265514, filed on Dec. 4, 2012, the entire contents of which are incorporated herein by reference.

### BACKGROUND

(1) Field

One or more embodiments of the present disclosure relates to a heat resistant seal member having high heat resistance and having hydrogen sulfide resistance.

(2) Description of Related Art

A heat resistant seal member in which one type of vapor-grown carbon fibers having a mean diameter exceeding 30 nm but not exceeding 200 nm and carbon black having a mean particle size between 25 nm and 500 nm are combined with a ternary fluoroelastomer has been developed (for example, International Publication WO2009/125503 which is referred to Patent Document 1). Introducing such heat resistant seal member having heat resistance as a static seal member for down-hole device in order to, for example, search for underground resources such as oil, natural gas, and the like, allowed for successful deeper drilling.

Further, a dynamic seal member has been developed in which either of carbon nanofibers having a mean diameter of between 10 nm and 20 nm or carbon nanofibers that have been subjected to a low-temperature heat treatment having a mean diameter between 60 nm and 110 nm is combined with a ternary fluoroelastomer (for example, International Publication WO2011/077595 which is referred to Patent Document 2). Such dynamic seal member has high mechanical properties and wear resistance in a high temperature at 200° C. or higher, and therefore, for example, could be adopted as the dynamic seal member for an oilfield use application.

However, in connection with the development of these heat resistant seal members, the drilling depth was able to be further deepened, and therefore, development of a heat resistant seal member that can withstand even harsher environments has been demanded. Such harsher environments include, for example, high concentration hydrogen sulfide gas at a high temperature that is generated in an oilfield and the surrounding area.

Further, carbon fiber composite with an excellent heat resistance using fluorine-containing elastomers and carbon nanofibers has been proposed in the past (for example, Japanese laid-open Patent Application Publication 2009-161652 which is referred to Patent Document 3); however, the materials proposed in the past had shown difficulty in withstanding a harsh environment, particularly use in a high concentration hydrogen sulfide gas at a high temperature for a long period of time.

### SUMMARY

One aspect of the present disclosure is to provide a heat resistant seal member having high heat resistance and hydrogen sulfide resistance.

A heat resistant seal member according to one embodiment of the present disclosure contains approximately 100 parts by weight of a ternary fluoroelastomer, 5 to 15 parts by weight of first carbon nanofibers having a mean diameter of not less than 60 nm and not more than 200 nm, 10 to 15 parts by weight of second carbon nanofibers having a mean diameter of not less than 9 nm and not more than 20 nm and 0 to 20 parts by weight of carbon black having a mean particle size between 25 nm and 500 nm. The first carbon nanofibers and the second carbon nanofibers are both contained therein, and the total amount of the first carbon nanofibers and the second carbon nanofibers is 15 to 30 parts by weight, and the total amount of the first carbon nanofibers, the second nanofibers, and the carbon black is 20 to 45 parts by weight.

According to the heat resistant seal member of one embodiment of the present disclosure, by combining a predetermined amount of the first carbon nanofibers and the second carbon nanofibers that have two different thicknesses, and dispersing them into the ternary fluoroelastomer uniformly, high heat resistance and excellent hydrogen sulfide resistance can be obtained.

A heat resistant seal member according to one embodiment of the present disclosure contains an elastomer, the first carbon nanofibers and the second carbon nanofibers that are dispersed in the elastomer, the first carbon nanofibers form a plurality of first cell structures, and the second carbon nanofibers form a plurality of second cell structures while surrounding the plurality of the first cell structures.

### BRIEF DESCRIPTION OF THE DRAWINGS

FIG. 1 is a drawing schematically illustrating a mixing and kneading method of a fluorine-containing elastomer, first carbon nanofibers, and second carbon nanofibers by an open roll method used in one embodiment of the present disclosure.

FIG. 2 is a schematic diagram describing a usage condition of a down-hole device.

FIG. 3 is a schematic diagram illustrating one section of the down-hole device.

FIG. 4 is a vertical cross-sectional view illustrating a coupled section of a pressure vessel of the down-hole device.

FIG. 5 is a vertical cross-sectional view illustrating other single-use form of an O-ring for the down-hole device.

FIG. 6 is a vertical cross-sectional view illustrating other single-use form of the O-ring for the down-hole device.

FIG. 7 is a cross-sectional view schematically illustrating a logging tool for subsea use.

FIG. 8 is a partial cross-sectional view schematically illustrating the logging tool of FIG. 7.

FIG. 9 is a X-X′ cross-sectional view schematically illustrating a mud motor of the logging tool in FIG. 8.

FIG. 10 is a cross-sectional view schematically illustrating a logging tool for underground use.

FIG. 11 is a vertical cross-sectional view schematically illustrating a testing device for a wear resistance test.

FIG. 12 is schematic view describing a structure of the heat resistant seal member according to one embodiment.

### DETAILED DESCRIPTION

Some embodiments will now be described with reference to the figures. Like elements in the various figures may be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, “upstream” and “downstream”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship, as appropriate.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both objects or steps, respectively, but they are not to be considered the same object or step.

The terminology used in the description herein is for the purpose of describing particular embodiments only and is not intended to be limiting of the disclosure and embodiments presented herewith. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

A heat resistant seal member according to one embodiment of the present embodiment contains: 100 parts by weight of a ternary fluoroelastomer; 5 to 15 parts by weight of first carbon nanofibers having a mean diameter of not less than 60 nm and not more than 200 nm; 10 to 15 parts by weight of second carbon nanofibers having a mean diameter of not less than 9 nm and not more than 20 nm; and 0 to 20 parts by weight of carbon black having a mean particle size between 25 nm and 500 nm; wherein the first carbon nanofibers and the second carbon nanofibers are both contained therein, and the total amount of the first carbon nanofibers and the second carbon nanofibers are between 15 to 30 parts by weight, and the total amount of the first carbon nanofibers, the second nanofibers, and the carbon black is 20 to 45 parts by weight.

Further, a heat resistant seal member according to one embodiment of the present disclosure contains: an elastomer, the first carbon nanofibers, and the second carbon nanofibers that are dispersed in the elastomer; the first carbon nanofibers form a plurality of first cell structures, and the second carbon nanofibers form one or more second cell structures while surrounding the plurality of the first cell structures.

Embodiments of the present disclosure will be described in detail hereinafter with reference to the drawings.

(I) Elastomers

Examples of elastomers that can be used in one embodiment of the present embodiment include natural rubber (NR), elastomers such as epoxydized natural rubber (ENR), styrene-butadiene rubber (SBR), nitrile rubber (NBR), chloroprene rubber (CR), ethylene-propylene rubber (EPR, EPDM), butyl rubber (IIR), chloro-butyl rubber (CIIR), acrylic rubber (ACM), silicone rubber (Q), fluoro-rubber (FKM), butadiene rubber (BR), epoxidized butadiene rubber (EBR), epichlorohydrin rubber (CO, CEO), urethane rubber (U), or polysulfide rubber (T); olefins (TPO), polyvinyl chlorides (TPVC), polyesters (TPEE), polyurethanes (TPU), polyamides (TPEA), and styrenes (SBS); and mixtures thereof.

A weight-average molecular weight of elastomers can be between 5,000 and 5 million, and in according to an example embodiment between 20,000 and 3 million. When the molecular weight of the elastomer is within this range, the elastomer molecules are interwound together, and because they are mutually connected, the elastomers have favorable elasticity to disperse the first carbon nanofibers and the second carbon nanofibers. The elastomer has viscosity, and therefore the aggregated first carbon nanofibers and second carbon nanofibers exhibit improved mutual penetration.

A ternary fluoroelastomer can be used as an elastomer in case of high heat resistance. An embodiment where a ternary fluoroelastomer is used as the elastomer will be described in the following description.

The ternary fluoroelastomer used in one embodiment of the present embodiment is synthetic rubber of a vinylidene fluoride that contains a fluorine atom in the molecule, and it is also referred to as a ternary fluororubber, and examples include, for example, ternary copolymers (VDF-HFP-TFE) of vinylidene fluoride (VDF)—hexafluoro-propylene (HFP)—tetrafluoroethylene (TFE), ternary copolymers (VDF-HFP-TFE) of vinylidene fluoride (VDF)—perfluoro (methyl vinyl ether) (FMVE)—tetrafluoroethylene (TFE), and the like. Examples of ternary fluoroelastomers include, for example, product name VITON, manufactured by DUPONT, product name DAI-EL G manufactured by DAIKIN INDUSTRIES, LTD., and the like. In the following description, the ternary fluoroelastomer is abbreviated as FKM. The FKM can have a weight-average molecular weight of between 50,000 and 300,000. When the molecular weight of the FKM is within this range, the FKM is interwound together, and because they are mutually connected, the FKM can have favorable elasticity to disperse the first carbon nanofibers and the second carbon nanofibers. The FKM has viscocity, and therefore, the aggregated cabon nanofibers easily mutually penetrate, and the carbon nanofibers can be separated on account of having elasticity. When the weight-average molecular weight of FKM is less than 50,000, the FKM cannot mutually interwind fully, so there is a tendency to reduce the effect of dispersing the carbon nanofibers due to a low elasticity even when a shear force is applied later. Further, when the weight-average molecular weight of FKM is greater than 300,000, the FKM becomes too hard such that there is a tendency to be difficult to work with. Because the FKM has superior high temperature properties even though the wear resistance is slightly unfavorable compared to a hydrogenated acrylonitrile butadiene rubber (HNBR), it can be used, for example, as a seal member for a logging tool, particularly as a dynamic seal member under an environment of a temperature of 175° C. or above at which the HNBR would deteriorate. The FKM can be used even in a high temperature environment between 175 and 200° C. Furthermore, the FKM has wear resistance at high temperature although weaker chemical resistance compared to tetrafluoroethylene-propylene copolymer (FEPM). The FKM used in one embodiment of the present embodiment can have having 66 to 70 wt % of fluorine content, a center value of the Mooney viscosity (ML₁₊₄121° C.) between 25 and 65, and a glass-transition point of 0° C. or below. When the fluorine content is 66 wt % or more, it increases in heat resistance, and when the fluorine content is 70 wt % or less, it increases in chemical resistance such as in alkali resistance, acid resistance, chlorine resistance and the like. Further, when the center value of the Mooney viscosity (ML₁₊₄121° C.) is 25 or more, it can have basic performance requirements such as tensile strength (TS), compression set (CS), and the like, and when the center value of the Mooney viscosity (ML₁₊₄121° C.) is 65 or less, a moderate viscosity can be obtained. For example, underground resource exploration may be performed under the ocean floor, water temperature can be approximately 4° C. due to high pressure at the bottom of the ocean, and therefore, this is capable of being used as a dynamic seal member from the ocean floor to an exploration zone with high temperature if the glass-transition point of the FKM is 0° C. or below.

The ternary fluoroelastomer is measured by Hahn-echo method using a pulsed NMR, and the spin-spin relaxation time (T2n/30° C.) of the network component when measured at a temperature of 30° C. and using 1H as the observation nucleus can be between 30 and 100μ seconds, and according to an example embodiment between 45 and 60μ seconds. Having the spin-spin relaxation time (T2n/30° C.) in the range described above, fluorine-containing elastomers can have a flexible and sufficiently high molecular mobility, which is to say that suitable elasticity for dispersing carbon nanotubes can be obtained. Further, the fluorine-containing elastomers have viscosity, and therefore, when the fluorine-containing elastomers and the carbon nanotubes are mixed, the fluorine-containing elastomers can exhibit increased penetration into spaces between the carbon nanotubes due to the high molecular motion. When the spin-spin relaxation time (T2n/30° C.) is shorter than 30μ seconds, fluorine-containing elastomers cannot have sufficient molecular motion. Furthermore, when the spin-spin relaxation time (T2n/30° C.) is longer than 100μ seconds, the fluorine-containing elastomers tend to flow as a liquid with low elasticity (having viscosity), and therefore, the carbon nanotubes are less likely to disperse.

The spin-spin relaxation time obtained by the Hahn-echo method using a pulsed NMR is a scale indicating the molecular mobility of a substance. Specifically, when the spin-spin relaxation time of the ternary fluoroelastomer by the Hahn-echo method using a pulsed NMR is measured, a first component having a first spin-spin relaxation time (T2n) that is a short relaxation time and a second component having a second spin-spin relaxation time (T2nn) that is a longer relaxation time are detected. The first component corresponds to the network component (scaffold molecule) of high molecule, and the second component corresponds to a non-network component (component of a branch such as a terminal chain) of a high molecule. Further, the shorter the first spin-spin relaxation time, the lower the molecule mobility, and the ternary fluoroelastomer may be described as “hard.” Moreover, the longer the first spin-spin relaxation time, the higher the molecule mobility, and the ternary fluoroelastomer could be described as “soft.”

The measurement method used in the pulsed NMR, does not have to be the Hahn-echo method, but a solid-echo method, a CPMG method (Carr-Purcell-Meiboom-Gill method), or even a 90° pulse method can be applied. However, the Hahn-echo method may be more suitable because the heat resistant seal member of one embodiment of the present disclosure has a medium degree spin-spin relaxation time (T2). In general, the solid-echo method and 90° pulse method are suitable for measuring a short T2, the Hahn-echo method is suitable for measuring a mid-length T2, and the CPMG method is suitable for measuring a long T2.

The ternary fluoroelastomer has first carbon nanofibers and second carbon nanofibers, and particularly a halogen group having affinity to a radical of the terminal. As an example, the first carbon nanofibers and the second carbon nanofibers may be configured with a six-membered ring at a lateral face, and the tip has a closed structure with a five-membered ring; however, due to structural limitations, defects can occur in practice and radicals and functional groups can be generated in that part. In the present embodiment, the ternary fluoroelastomer, the first carbon nanofibers and the second carbon nanofibers can be bonded by having a halogen group with a high affinity (reactivity or polarity) to the radical of the first carbon nanofibers and the second carbon nanofibers in at least one of a principal chain, a side chain, or a terminal chain of the ternary fluoroelastomer. This allows increased dispersion while resisting the cohesive force of the first carbon nanofibers and the second carbon nanofibers.

The ternary fluoroelastomer of the present embodiment can be kneaded uncross-linked as is with the first carbon nanofibers and the second carbon nanofibers.

(II) First Carbon Nanofibers and Second Carbon Nanofibers

The heat resistant seal member according an example embodiment contains both first carbon nanofibers and second carbon nanofibers. The heat resistant seal member has good balance in rigidity and flexibility while having heat resistance and wear resistance by containing two types of the first carbon nanofibers and the second nanofibers, and it can withstand usage for a long period of time in harsher environments (for example, hydrogen sulfide gas of high temperature and high concentration that is produced in the vicinity of oilfields, or the like) when a drilling depth is deeper. On the other hand, a seal member containing one of either the first carbon nanofibers or the second carbon nanofibers is less likely to withstand usage for a long period of time in a harsher environment when the drilling depth is deeper as compared to the dynamic seal member proposed, for example, in Patent document 2 (International Publication WO2011/077595) described in the Background section.

The first carbon nanofibers are capable of having a mean diameter smaller than the second carbon nanofibers.

The mean diameter of the first carbon nanofibers is not less than 60 nm and not more than 200 nm. Further, the first carbon nanofibers can have a mean diameter that is not less than 60 nm and not more than 100 nm, and it may even have a mean diameter of not less than 60 nm and not more than 80 nm. Improvement in the rigidity and improvement of the heat resistance can be expected by blending carbon nanofibers into the ternary fluoroelastomer. Particularly, a so-called macrocell, a relatively large cell to surround the ternary fluoroelastomer, is formed by blending the first carbon nanofibers having a mean diameter of not less than 60 nm and not more than 200 nm, and therefore, the first carbon nanofibers can have an excellent flexibility in the heat resistant seal member. The mean length of the first carbon nanofibers can be 1 μm or above.

The mean diameter of the second carbon nanofibers is more than 9 nm and not more than 20 nm. A so-called nanocell, a relatively small cell to surround the ternary fluoroelastomer, is formed by blending the second carbon nanofibers having a mean diameter of more than 9 nm and not more than 20 nm, and therefore, the second carbon nanofibers can have an excellent wear resistance in the heat resistant seal member. However, although the second carbon nanofibers can improve the rigidity of the heat resistant seal member by mixing a small amount, there is a tendency to lose flexibility of the heat resistant seal member. Thereby, the flexibility of the heat resistant seal member can be maintained by mixing a suitable amount of the first carbon nanofibers instead of mixing the second carbon nanofibers alone. Further, the mean length of the second carbon nanofibers can be 1 μm or above.

The first carbon nanofibers and the second carbon nanofibers have a multilayer structure having a cylindrical shape by wrapping a single sheet (graphene sheet) of graphite having a hexagonal carbon surface, also known as a multiwall carbon nanotube (MWNT), a vapor-grown carbon fiber, or the like. Note that, in the detailed description of embodiments of the present disclosure, the mean diameter and the mean length of the first and second carbon nanofibers can be obtained by measuring the mean lengths and diameters of 200 or more fibers from, for example, a 5,000-zoom image (the magnification can be changed suitably according to the size of a carbon nanofibers) using a scanning electron microscope, and calculating the arithmetic mean value.

Such first carbon nanofibers and second carbon nanofibers can be prepared by various vapor growth methods. The vapor growth method pyrolyzes hydrocarbon such as benzene, toluene, and the like in a vapor phase, and synthesizes the first carbon nanofibers and the second carbon nanofibers, and more specifically, examples include a fluid catalyst method, a zeolite supported catalyst method, or the like. The first carbon nanofibers and the second carbon nanofibers can be obtained by using an organic compound such as benzene, toluene, natural gas, or the like as an ingredient, and causing a pyrolysis reaction with hydrogen gas at a temperature between 800° C. and 1300° C. in the presence of a transition metal catalyst such as ferrocene. Further, the first carbon nanofibers and the second carbon nanofibers can have a graphitization treatment with a graphitization catalyst such as boron, boron carbide, beryllium, aluminum, silicon, or the like at a temperature, for example, between 2,300° C. and 3,200° C.

The first carbon nanofibers and the second carbon nanofibers can be improved in adhesiveness and wettability by conducting a surface treatment in advance, for example, ion implantation processing, sputter etching processing, plasma treatment, and the like prior to kneading with the elastomer.

(III) Carbon Black

In addition to the first carbon nanofibers and the second carbon nanofibers, carbon black can be also blended. The carbon black used in one embodiment of the present disclosure has a mean particle size between 25 nm and 500 nm. Further, the carbon black is capable of having a mean particle size between 70 nm and 250 nm. The mean particle size of the carbon black can be provided pre-measured by a manufacturer if it is commercially available; however, the arithmetic mean value of carbon black can be found by observing an image of a transmission electron microscope and measuring a particle diameter of 2,000 or more particles considering an aggregated configuration as a single particle (fundamental particle). Furthermore, carbon black can have a DBP oil absorption between 10 and 150 ml/100 g, and even between 15 and 50 ml/100 g. Particularly, FT grade carbon black, MT grade carbon black, or the like can be used as the carbon black that can satisfy such conditions. The heat resistant seal member can be reinforced by using a predetermined amount of the carbon black having a relatively large particle diameter. Accordingly, a matrix area of the ternary fluoroelastomer can be divided into a number of micro areas by the carbon black, and therefore, the divided micro areas are sufficient to be enforced with the carbon nanofibers so that a filling rate of the carbon nanofibers that are relatively expensive can be reduced. In particular, bound rubber is formed around the carbon black in the elastomer composition, and therefore, the filling rate of the carbon nanofibers can be reduced with greater efficiency. Particularly, the hardness can be improved while suppressing the compression set in the heat resistant seal member by blending a predetermined amount of carbon black into the ternary fluoroelastomer.

An example heat resistant seal member contains 100 parts by weight of a ternary fluoroelastomer, 5 to 15 parts by weight of first carbon nanofibers, 10 to 15 parts by weight of second carbon nanofibers, and 0 to 20 parts by weight of carbon black having a mean particle size of between 25 nm and 500 nm. Further, in an example heat resistant seal member, for 100 parts by weight of a ternary fluoroelastomer, the total amount of the first carbon nanofibers and the second carbon nanofibers is 15 to 30 parts by weight, and the total number of the first carbon nanofibers, the second carbon nanofibers, and the carbon black is 20 to 45 parts by weight.

Furthermore, in an example heat resistant seal member, by blending two different types of carbon nanofibers with a different thickness in such manner into the ternary fluoroelastomer, can have a time until leakage of not less than 40 hours and not more than 100 hours when conducting a wear resistance test under condition of 175° C., 35 MPa, and 5 mm/sec. A description of the wear resistance test will be given in detail in the disclosure.

Moreover, an example heat resistant member can have a compression set of 40% or less, for example more than 0% and not more than 40%, at a compressibility of 25% for 70 hours under hydrogen sulfide gas atmosphere and a temperature of 200° C. by blending such two types of carbon nanofibers having a different thickness into the ternary fluoroelastomer. Also, the heat resistant seal member has good balance in rigidity and flexibility while having heat resistance and wear resistance by blending a predetermined amount of two types of carbon nanofibers.

When the total combined amount of the first carbon nanofibers and the second carbon nanofibers is 15 parts by weight or above for 100 parts by weight of the ternary fluoroelastomer, wear resistance can be improved in particular from the formation of micro areas (nano-sized cells) that are surrounded by the extremely fine carbon nanofibers. Further, when the total amount is 30 parts by weight or less, workability due to a decrease in elongation characteristic and ease of installation can be improved. Furthermore, the total combined amount of the first carbon nanofibers and the second carbon nanofibers is capable of having 15 to 25 parts by weight, and may even have 20 to 25 parts by weight.

Further, the heat resistant seal member can contain, for example, 100 parts by weight of a ternary fluoroelastomer, 5 to 8 parts by weight of the first carbon nanofibers, 12 to 15 parts by weight of the second carbon nanofibers, and 10 to 15 parts by weight of carbon black, wherein the total amount of carbon nanofibers in which the first carbon nanofibers and the second carbon nanofibers are combined is 15 to 23 parts by weight, and the total amount of the first carbon nanofibers, the second carbon nanofibers, and the carbon black is 27 to 38 parts by weight.

(IV) Obtaining the Heat Resistant Seal Member

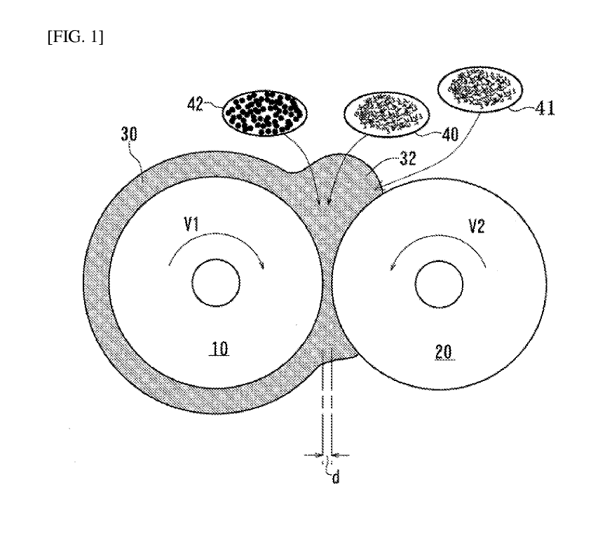

A description will be given using FIG. 1 of an example of using an open roll method that performs tight milling with a roll spacing of not more than 0.5 mm to obtain an example embodiment of a heat resistant seal member according to the present disclosure.

FIG. 1 is a drawing schematically illustrating an open roll method using two rolls. In FIG. 1, reference numeral 10 illustrates a first roll, and reference numeral 20 illustrates a second roll. The first roll 10 and the second roll 20 are positioned at a predetermined spacing d of, for example, 1.5 mm. The first and second rolls rotate forward or reverse. In the example in the drawing, the first roll 10 and the second roll 20 rotate in the directions indicated by the arrow.

First, while the first and second rolls 10 and 20 are rotating, an elastomer, for example the ternary fluoroelastomer 30, is wound in the first roll 10 such that the ternary fluoroelastomer accumulates between rolls 10 and 20 forms a so-called bank 32. First, carbon black 42 is added to the bank 32 and kneaded as appropriate, then the first carbon nanofibers 40 and the second carbon nanofibers 41 are added, and the first and second rolls 10 and 20 are rotated to obtain a mixture of the ternary fluoroelastomer, carbon black 42, the first carbon nanofibers 40, and the second carbon nanofibers 41. This mixture is removed from the open roll. Further, the spacing d of the first roll 10 and the second roll 20 can be set to not more than 0.5 mm and according to an example embodiment, set to a spacing between 0.1 and 0.5 mm and the obtained mixture is introduced into the open roll for tight milling. The number of times for tight milling can be to be performed approximately, for example, between three times and 10 times. When the surface speed of the first roll 10 is V1 and the surface speed of the second roll 20 is V2, the surface speed of both (V1/V2) during tight milling can be between 1.05 and 3.00, and according to an example embodiment between 1.05 and 1.2. Using this type of surface speed ratio allows a desired shear force to be obtained.

A shear force obtained in this way allows a high shear force to be activated on the ternary fluoroelastomer 30 such that the aggregated first carbon nanofibers 40 and second carbon nanofibers 41 can be mutually separated so as to be extracted one strand at a time on the ternary fluoroelastomer molecule, and are dispersed in the ternary fluoroelastomer 30.

Further, introducing the carbon black 42 into the bank 32 prior to the introduction of the first carbon nanofibers 40 and the second carbon nanofibers 41 causes a turbulent flow around the carbon black 42 due to the shear force of the roll and allows the first carbon nanofibers 40 and the second carbon nanofibers 41 to be uniformly dispersed by the ternary fluoroelastomer 30.

To achieve as high a shear forces possible, the mixing of the first carbon nanofibers and the second carbon nanofibers with the ternary fluoroelastomer can be done at a temperature between 0 and 50° C., and moreover, and it can be performed at a relatively low temperature between 5 and 30° C. Tight milling at such a low temperature allows the first carbon nanofibers and the second carbon nanofibers to be dispersed efficiently in the matrix because the ternary fluoroelastomer has rubber elasticity.

At this time, because the ternary fluoroelastomer of the present embodiment has the characteristic described above, meaning elasticity expressed by the molecular form (molecular length) and molecular motion of the ternary fluoroelastomer, viscosity, and chemical interaction with the first carbon nanofibers and the second carbon nanofibers providing easy distribution of the first carbon nanofibers and the second carbon nanofibers, a heat seal member having improved dispersibility and dispersion stability (difficulty of the first carbon nanofibers and the second carbon nanofibers to aggregate again) can be obtained. More specifically, when mixing the ternary fluoroelastomer with the first carbon nanofibers and the second carbon nanofibers, the ternary fluoroelastomer having viscosity penetrates the first carbon nanofibers and the second carbon nanofibers, and a specific portion of the ternary fluoroelastomer bonds with a high activity portion of the first carbon nanofibers and the second carbon nanofibers due to the chemical interaction. In this state, when a strong shear force is applied to the mixture of the ternary fluoroelastomer having an appropriately long molecular length and a high molecular mobility (having elasticity) and the first carbon nanofibers and the second carbon nanofibers, the first carbon nanofibers and the second carbon nanofibers also migrate in conjunction with the migration of the ternary fluoroelastomer, and the aggregated first carbon nanofibers and second carbon nanofibers separate according to the restoring force of the ternary fluoroelastomer due to the elasticity after shearing so as to be dispersed into the ternary fluoroelastomer. According to the present embodiment, when the mixture is pressed out from between the narrow rolls by tight milling, the mixture is formed thicker than the roll gap on account of the restoring force due to the elasticity of the ternary fluoroelastomer. That deformation can be assumed to cause the mixture that had a strong shear force applied to flow more complexly such that the first carbon nanofibers and the second carbon nanofibers are dispersed into the ternary fluoroelastomer. Further, once the first carbon nanofibers and the second carbon nanofibers have dispersed, re-aggregation is prevented due to the chemical interaction with the ternary fluoroelastomer thereby allowing it to have favorable dispersion stability.

The step where the first carbon nanofibers and the second carbon nanofibers are dispersed by the shear force to the ternary fluoroelastomer is not limited to the open roll method, but a closed kneading method or a multiaxial extrusion method may be used. This may involve a shear force that can separate the aggregated first carbon nanofibers and the second carbon nanofibers can be applied to the ternary fluoroelastomer.

The heat resistant seal member can be obtained by forming the elastomer composition obtained by mixing and dispersing in a predetermined shape by cross-linking using a cross-linking agent. Note that in, or following, the mixing and dispersing of the first carbon nanofibers and the second carbon nanofibers with the ternary fluoroelastomer, a compounding agent used in the working of the ternary fluoroelastomer such as rubber may be normally added. Known examples of compounding agents may include cros slinking agents, vulcanizing agents, vulcanization accelerators, vulcanization retarders, softeners, plasticizers, curing agents, reinforcing agents, fillers, anti-aging agents, coloring agents, and the like. For example, fillers other than carbon black, such as silica, clay, talc and the like may be combined. Especially in the case of silica, a mean particle diameter between 5 nm and 50 nm has an effect to divide the matrix into micro areas, similarly to carbon black, and therefore, the file rate of expensive carbon nanofiber can be reduced.

(V) Heat Resistant Seal Member

FIG. 12 is schematic view describing a structure of the heat resistant seal member according to one embodiment. In the heat resistant seal member 120 according to the present embodiment, the first carbon nanofibers form a plurality of first cell structures 100, and the second carbon nanofibers 102 form not less than 1 second cell structure 110 while encompassing the plurality of first cell structures 100. The first cell structures 100 are formed so as to encompass micro unit elastomers 104 by the first carbon nanofibers not illustrated. In FIG. 12, the first cell structures 100 are depicted as small circular particles for description purposes, but they are not limited to this. The plurality of first cell structures collect closely together to form a strip shape, and the second carbon nanofibers enclose the periphery of the strip to form the second cell structure 110.

In FIG. 12, the second cell structure 110 is illustrated on a plane, but this type of structure is formed three dimensionally. One or more second cell structure 110 is formed in the heat resistant seal member 120.

A description of the heat resistant seal member that uses a ternary fluoroelastomer as the elastomer will be described below according to other embodiments.

The heat resistant seal member according to another embodiment contains: 100 parts by weight of a ternary fluoroelastomer; 5 to 15 parts by weight of first carbon nanofibers having a mean diameter of not less than 60 nm and not more than 200 nm; 10 to 15 parts by weight of second carbon nanofibers having a mean diameter of not less than 9 nm and not more than 20 nm; and 0 to 20 parts by weight of carbon black having a mean particle size between 25 nm and 500 nm; wherein the first carbon nanofibers and the second carbon nanofibers are both contained therein, and the total amount of the first carbon nanofibers and the second carbon nanofibers is 15 to 30 parts by weight, and the total amount of the first carbon nanofibers, the second nanofibers, and the carbon black is 20 to 45 parts by weight.

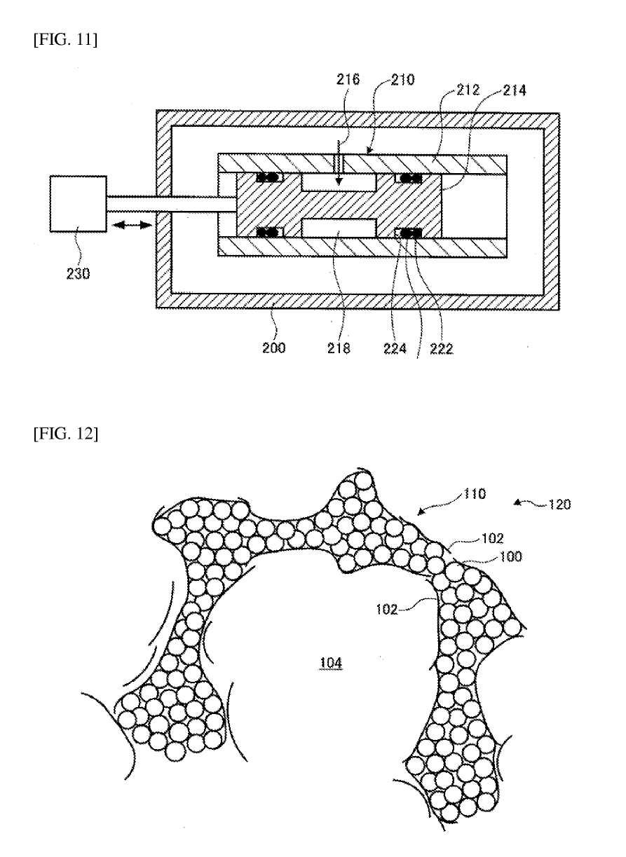

The heat resistant seal member according to the present embodiment can achieve a time not less than 40 hours and not more than 100 hours until leakage occurs in a wear resistance test under conditions of 175° C., 35 MPa, and 5 mm/sec. Further, the heat resistant seal member can achieve a time not less than 40 hours and not more than 70 hours until leakage occurs in a wear resistance test under conditions of 175° C., 35 MPa, and 5 mm/sec. A description of the wear resistance test will be given in detail in the embodiment using FIG. 11.

The heat resistant seal member according to the present embodiment can achieve a compression set of not more than 40% after 70 hours and 25% compressibility in a hydrogen sulfide gas atmosphere at 200° C., and it can, for example, be more than 0% but not more than 40%. The measurement method of the compression set complies with the National Association of Corrosion Engineers (NACE) TM0296 for heat resistant seal members. A description of the specific measurement method will be given in the embodiment. In the heat resistant seal member, first carbon nanofibers and second carbon nanofibers are uniformly dispersed in a ternary fluoroelastomer that as a base material (matrix), and as appropriate, disperses carbon black. An interfacial phase assumed to be an aggregate of ternary fluoroelastomer molecules that have adhered to the surface of the first carbon nanofibers and the second carbon nanofibers is formed around the circumference of the first carbon nanofibers and the second carbon nanofibers. The interfacial phase can be thought of something similar to bound rubber that is formed around the circumference of the carbon black when, for example, the ternary fluoroelastomer and the carbon black are kneaded. This type of interfacial phase covers and protects the first carbon nanofibers and the second carbon nanofibers, and mutual interfacial phases form a chain of micro cells as the amount of the first carbon nanofibers and the second carbon nanofibers in the heat resistant seal member increase. Furthermore, when the first carbon nanofibers and the second carbon nanofibers are in an optimal ratio in the heat resistant seal member, deterioration of the ternary fluoroelastomer is prevented inside the high temperature (for example, 200° C. or above) hydrogen sulfide by the nano sized micro cells to thereby hold the compression set low. Further, the compression set underwater at high temperature and high pressure can be held low for the heat resistant seal member. In addition, the friction resistance life of the heat resistant seal member can be extended. Note that use of further carbon black can decrease the fill ratio of the first carbon nanofibers and the second carbon nanofibers that occupy the entire heat resistant seal member.

An example heat resistant seal member can achieve a compression set of not more than 40% after 70 hours and 25% compressibility in a hydrogen sulfide gas atmosphere at 200° C., and it can, for example, be more than 0% but not more than 40%. Furthermore, an example heat resistant seal member can achieve a compression set of not more than 40% after 160 hours and 25% compressibility in a hydrogen sulfide gas atmosphere at 200° C., and it can, for example, be more than 0% but not more than 40%. An example heat resistant seal member can achieve a compression set of not more than 60% after 48 hours and 25% compressibility under water at 200° C., and it can, for example, be more than 0% but not more than 60%.

Further, an example heat resistant seal member can achieve a modulus of volume change of not more than 5.0% after retaining the heat resistant seal member within a container in carbon dioxide atmosphere of 800 psi at room temperature for 24 hours and then rapidly reducing the pressure within the container to ambient pressure in 2 seconds. For example, in oilfield applications and so forth, amounts of high pressure gas may penetrate into the inner part the heat resistant seal member when the heat resistant seal member is used in a high pressure gas atmosphere, and due to this, when a system using the heat resistant seal member rapidly reduces pressure, the gas on the inside of the heat resistant seal member expands and may cause damage or deformation to the heat resistant seal member. Therefore, the rapid decompression tolerance (ED tolerance) can be determined for the heat resistant seal member by rapidly decompressing under a high pressure gas environment using carbon dioxide and measuring the change in volume before and after testing the heat resistant seal member. A small change in volume of the heat resistant seal member before and after testing is desired and can be, for example, not more than 5.0%. The measurement method of the rapid decompression tolerance complies with the National Association of Corrosion Engineers (NACE) TM0297-97 for heat resistant seal members. A description of the specific measurement method will be given in the embodiment.

Further, with the heat resistant seal member, the first spin-spin relaxation time (T2n) is between 600 and 1,000μ seconds in an non-cross-linked observation nucleus measured at ¹H at 150° C. by the Hahn-echo method using pulsed NMR, and the component fraction (fnn) of the component having the second spin-spin relaxation time (T2nn) is below 0.2.

The T2n and fnn in an uncross-linked elastomer composition can indicate that the carbon nanofibers in an elastomer of a matrix are uniformly dispersed. In other words, carbon nanofibers being uniformly dispersed in a ternary fluoroelastomer means that the ternary fluoroelastomer molecule is constrained by the carbon nanofibers. In this state, the mobility of the ternary fluoroelastomer that is being constrained by carbon nanofibers is smaller than when not being constrained by the carbon nanofibers. Therefore, the first spin-spin relaxation time (T2n), the second spin-spin relaxation time (T2nn), and a spin lattice relaxation time (T1) of the heat resistant seal member in a non-cross-linked body according to the present embodiment are shorter than when a fluorine-containing elastomer that does not contain carbon nanofibers and are particularly shorter than when the carbon nanofibers are uniformly distributed.

Further, when the ternary fluoroelastomer is in a constrained state by carbon fibers, the non-network components (non-network chain components) are assumed to be reduced for certain reasons. In other words, reducing the overall molecular mobility of the ternary fluoroelastomer by carbon nanofibers is assumed to reduce the non-network components for reasons such as facilitating the non-network components to have similar behavior as the network components by increasing the areas that are no longer able to move easily, and because the non-network components (terminal chain) easily move, this facilitates adhesion with the active points of the carbon nanofibers. Therefore, the component fraction (fnn) of the component having the second spin-spin relaxation time (T2nn) becomes smaller than the fluorine-containing elastomer that does not contain carbon nanofibers. Note that, the component fraction (fn) of the component having the first spin-spin relaxation time (T2n) becomes larger than the ternary fluoroelastomer that does not contain carbon nanofibers because fn+fnn=1.

The heat resistant seal member can be used as a gasket used on a fixed part or as packing used on a movable part and is, for example, an endless seal member where the external form is a continuous endless shape. The external form of the endless seal member may be not just a circular shape but may have, for example, a polygon shape together with the shape of a groove or member that arranges the seal member. The endless seal member can be an O-ring having a circular lateral cross-section. Further, the endless seal member can be selected from among, for example, so-called D rings, X rings, and lip rings (U lip rings, V lip rings, and the like).

(VI) Oilfield Applications

The heat resistant seal member may be used in, for example, oilfield apparatus as an oilfield application. The following is a description of a representative embodiment of an oilfield apparatus.

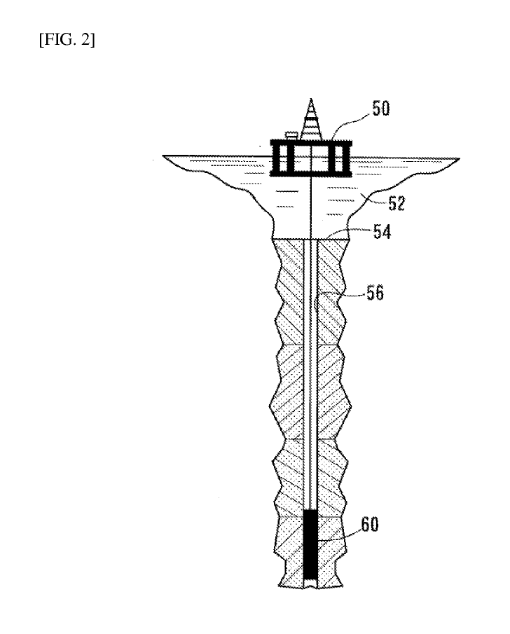

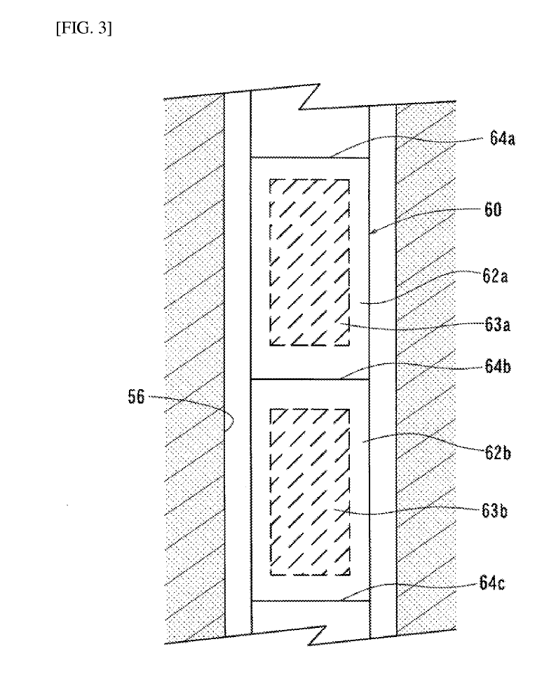

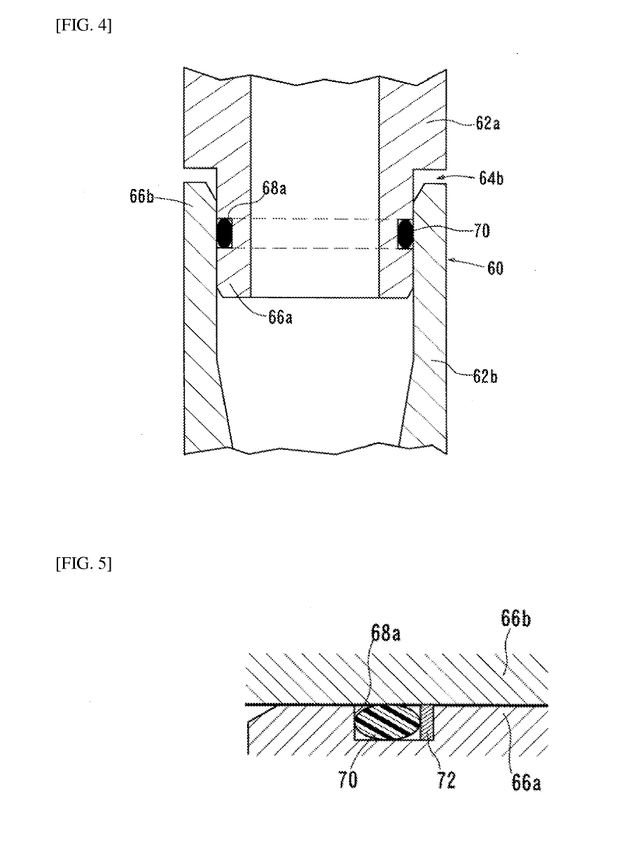

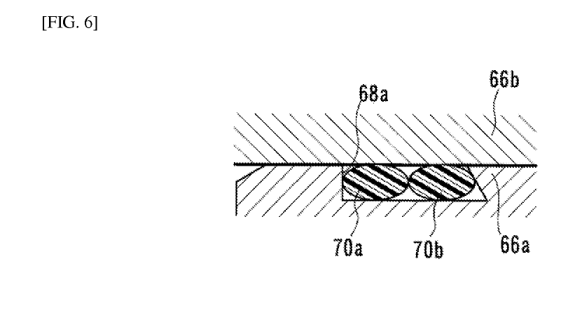

FIG. 2 is a schematic diagram describing a usage condition of a down-hole device. FIG. 3 is a schematic diagram illustrating one section of the down-hole device. FIG. 4 is a vertical cross-sectional view illustrating a coupled section of a pressure vessel of the down-hole device. FIG. 5 is a vertical cross-sectional view illustrating another single-use form of the O-ring for the down-hole device. FIG. 6 is a vertical cross-sectional view illustrating another single-use form of the O-ring for the down-hole device.

As illustrated in FIG. 2, the search for underground resources is the search for geological structures underground by, for example, inserting a down-hole device 60 into a well 56 configured for a vertical hole or a lateral hole provided on the ocean floor 54 from a platform 50 floating on the ocean 52 to search for the existence of target resources such as oil. The down-hole device 60 is, for example, fixed on the tip end of a long rod that extends from the platform and has a plurality of pressure vessels 62a and 62b as illustrated in FIG. 3, or it may have a drill bit not shown on the tip thereof. The pressure vessels 62a and 62b are coupled and sealed liquid-tight to adjacent pressure vessels by coupling sections 64a, 64b, and 64c on both ends. Electronic devices 63a and 63b such as an acoustic logging system or the like are enclosed in the inner part of the pressure vessels 62a and 62b to enable search for geographic structures and the like underground.

As illustrated in FIG. 4, the end portion 66a of the pressure vessel 62a is a cylindrical shape having a slightly smaller outer diameter than the inner diameter of the end portion 66b of the pressure vessel 62b, and the endless heat resistant seal member, for example an O-ring 70, is fit into an endless groove 68a provided on the perimeter of the end portion 66a. The O-ring 70 is an endless seal member with a circular lateral cross-section, having an external form in a continuous circle, and is formed using the heat resistant seal member. The end portion 66a of the pressure vessel 62a enters into the inner side of the end portion 66b of the pressure vessel 62b, and the coupling section 64b of the pressure vessels 62a and 62b is sealed liquid-tight by the O-ring 70 being crushed flat in the assembly. The down-hole device 60 holds the pressure vessels 62a and 62b liquid-tight under high pressure and high temperature in order to work in the well 56 that is deeply dug into the ground. The O-ring 70 for use in the down-hole device 60 according to this embodiment has little elastomer deterioration at high temperature while maintaining high flexibility and high strength even at a high temperature.

As illustrated in FIG. 5, for example, a backup ring 72 made of resin may be placed in the endless groove 68a with the O-ring 70, and as illustrated in FIG. 6, sealing may be improved by placing, for example, or rings 70a and 70b together in parallel in the endless groove 68a.

Further, the heat resistant seal member can be used as a dynamic seal member in, for example, a logging tool, a rotary machine such as a motor, or a reciprocating machine such as a piston. The logging tool is a device for recording, at various depths, for example, physical characteristics such as ground layers and oil layers in and around a drilled borehole, geometric characteristics of the borehole or casing (hole diameter, orientation, slant, and the like), behavior of an oil layer flow, and like, and can be used, for example, in an oilfield.

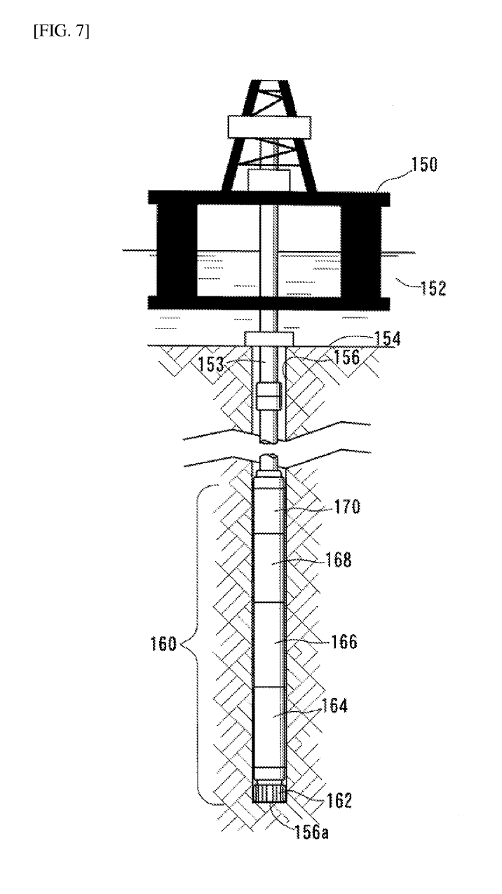

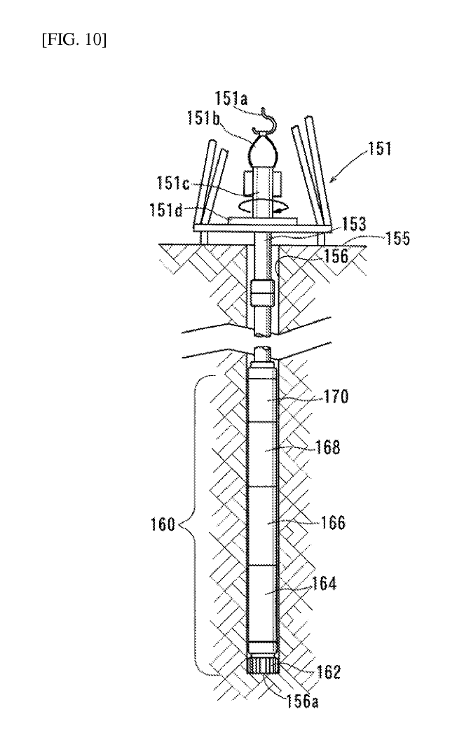

Examples of the logging tool applied to an oilfield include subsea applications as illustrated in FIG. 7 and underground applications as illustrated in FIG. 10. With the logging tool, there is wireline log/logging, mud logging, and the like, and there is logging while drilling (LWD), measurement while drilling (MWD), and the like where a measuring instrument is mounted on the drilling assembly. These logging tools, in order to work in deep locations underground, maintain a liquid-tight state and withstand friction in an exposed state at a high temperature, particularly 175° C. and above, with the surrounding environment harsh on the dynamic seal member, and heat resistance higher than an HNBR compound material is demanded.

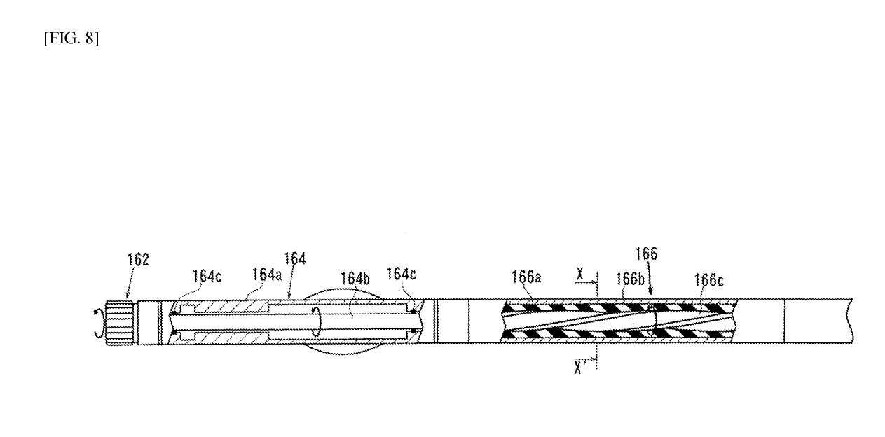

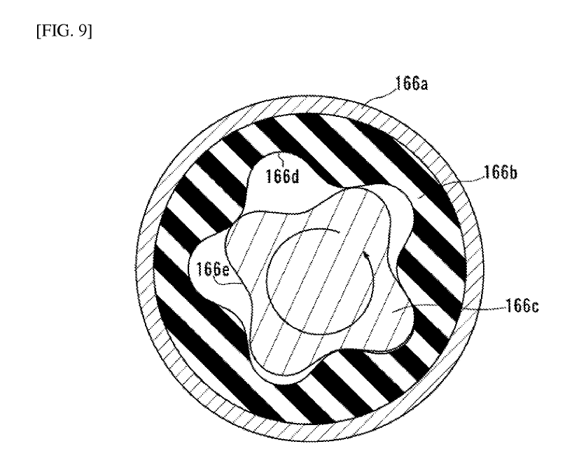

Referencing FIGS. 7 to 10, a description will be given of a dynamic seal member of one embodiment of the present disclosure in which a logging tool is used. FIG. 7 is a cross-sectional view schematically illustrating a logging device for subsea use according to one embodiment of the present disclosure. FIG. 8 is a partial cross-sectional view schematically illustrating the logging device of FIG. 7 according to one embodiment of the present disclosure. FIG. 9 is a X-X′ cross-sectional view schematically illustrating a mud motor of the logging device in FIG. 8. FIG. 10 is a cross-sectional view schematically illustrating a logging device for underground use according to one embodiment of the present disclosure.

As illustrated in FIG. 7, the search for underground resources in the sea using measuring devices mounted on drilling assemblies is the search for geological structures underground by, for example, inserting a bottom hole assembly (BHA) 160, for example, as the logging tool into a borehole 156 configured for a vertical hole or a lateral hole provided on the ocean floor 154 from a platform 150 floating on the ocean 152 to search for the existence of target resources such as oil. The bottom hole assembly 160 has, for example, a plurality of modules fixed to the tip end of a long drill string 153 that extends from the platform 150, and can link, in order from the tip end, for example, a drill bit 162, a rotary steerable system (RSS) 164, a mud motor “moter” 166, a measure while drilling module 168, and logging while drilling module 170. The drill bit 162 can drill by rotating in a bottom hole section 156a of a borehole 156.

The rotary steerable system 164 illustrated in FIG. 8 has a biasing mechanism not illustrated that biases the bit in a fixed direction while rotating the drill bit 162 and is a system that can perform tilt control drilling. The dynamic seal member of one embodiment of the present disclosure can apply to the rotary steerable system 164. The rotary steerable system 164 can have a dynamic seal member that has high wear resistance at a maximum temperature of, for example, approximately 210° C. or a dynamic seal member that has high chemical resistance to exposure in various mud waters. Conventional dynamic seal members may stop functioning due to wear and rupture of the rubber. This may be a serious problem particularly in harsh chemical environments. Although there is demand for the dynamic seal member for a rotary steerable system such as that disclosed in US Patent Application Publication No. 2006/0157283 to achieve a high sliding speed (˜100 mm/sec), such seal member may exhibit reduced elastomer characteristics in the use temperature and wear characteristics of the drilling fluid. In contrast to this, using the dynamic seal member of one embodiment of the present disclosure as the dynamic seal member of the rotary steerable system 164 can resolve the various problems described above, in addition to the characteristics of the dynamic seal member described above, by providing high wear resistance for sealing from drill mud that includes particles, more excellent chemical resistance against common drilling fluids, and improved mechanical properties that reduce ruptures at high temperatures. The rotary steerable system 164 has a cylindrical casing 164a that does not rotate, a transmission shaft 164b that transfers rotary power of the mud motor 166 to the drill bit 162 by passing through into the casing 164a, and a dynamic seal member 164c that rotatably supports the transmission shaft 164b within the casing 164a. The dynamic seal member 164c can be, for example, an endless O-ring fit into a ring shaped groove provided in the casing 164a and can have a function for sealing between the surfaces of the rotating transmission shaft 164b. Because the dynamic seal member 164c is the dynamic seal member obtained in (IV) described above and has improved wear resistance even in harsh environments underground at high temperatures of, for example, approximately 175° C., it can maintain a sealing function for a long period of time. Use of this type of dynamic seal member can be seen in, for example, US Patent Application Publication No. 2006/0157283 and U.S. Pat. No. 7,188,685 which are incorporated in their entirety in the present specification. More specifically, FIG. 5 of US Patent Application Publication No. 2006/0157283 illustrates a seal member 38 on a piston 36 that seals a hole 30 on a biasing device of a rotary variable assembly. U.S. Pat. No. 7,188,685 illustrates a biasing device.

The mud motor 166 illustrated in FIG. 9, also referred to as a down-hold motor, is a fluid drive motor for rotating the drill bit 162 to make the hydrodynamics of the mud water to become motive power. An example of the mud motor 166 that the dynamic seal member of one embodiment of the present disclosure applies to is a mud motor for deviated wellbore drilling applications. The mud motor 166 can have, for example, a dynamic seal member having maximum high temperature characteristics of approximately between 150° C. and 200° C., a dynamic seal member that can function under extreme wear conditions, or a dynamic seal member that has chemical resistance for handling various types of drill mud. There is a tendency for the conventional dynamic seal members in mud motors to have, for example, insufficient sealing due to expansion of the dynamic seal member, cracking and detachment of large fragments (chunking) of the dynamic seal member main body, insufficient sealing due to wear at high temperature, and local heating and further deterioration of the dynamic seal member due to wear action on the dynamic seal member. In contrast to this, using the dynamic seal member of one embodiment of the present disclosure as the dynamic seal member of the mud motor 166 can resolve the various problems described above, in addition to the characteristics of the dynamic seal member described above, by reducing rupture and detachment with mechanical properties that are more excellent in high temperatures, resistance to commonly used drilling fluids through excellent chemical resistance, and by reducing areas of local heating through more excellent thermal conductivity. The mud motor 166 has a cylindrical casing 166a and a tubular stater 166 is secured to the inner peripheral surface of the casing 166a, and a rotor 166c is rotatably placed on the inner side of the stater 166d. The inner peripheral surface 166d of the stater 166b has, for example, five spiral grooves that extend from the rotary steerable system 164 side to the measure while drilling module 168 side. The stater 166b may use the dynamic seal member of one embodiment of the present disclosure obtained in (IV) described above. For example, the outer peripheral surface 166e of the metallic rotor 166c has, for example, four threads that protrude spirally and is placed along the groove on the inner peripheral surface 166d of the stater 166b. The inner peripheral surface 166d of the stater 166b and the outer peripheral surface 166e of the rotor 166c are in partial contact as illustrated in FIG. 9 so that a flow path is formed where mud water can flow in the gap 166f between the inner peripheral surface 166d and the outer peripheral surface 166e. The contact between the mud water that flows in the gab 166f and the outer peripheral surface 166e of the rotor 166c allows the rotor 166c to rotate eccentrically within the stater 166b in, for example, the direction indicated by the arrows in FIG. 8 in FIG. 9. At this time, because the inner peripheral surface 166d of the stater 166b and the outer peripheral surface 166e of the rotor 166c are in contact and eccentrically rotating by the mud water, the inner peripheral surface 166d of the stater 166b functions in a similar manner to a so-called dynamic seal member. Accordingly, on account of the improved wear resistance even in harsh environments underground such as that described above, the rotor 166c of the mud motor 166 can be driven to rotate for a long period of time. Note that in the present embodiment, a description was given using the mud motor 166 as a fluid drive motor, but other fluid drive motors may be used that drive by using fluid and that have a similar structure, and the rotor can be formed by the dynamic seal member obtained in (IV) described above and stater can be formed of, for example, metal. Use of this type of dynamic seal member can be seen in, for example, US Patent Application Publication No. 2006/0216178 and U.S. Pat. No. 6,604,922 which are incorporated in their entirety in the present specification. More specifically, FIG. 3 of US Patent Application Publication No. 2006/0216178 illustrates a seal member has an elastomer stater (lining) that seals the rotor and generates drilling torque on the rotor. The mud flows between the stater and the rotor. Further, FIG. 4 of the same illustrates a seal member as an elastomer sleeve attached to the rotor that seals the stater. In FIG. 5 of the same, a seal member is illustrated as an elastomer sleeve on the rotor that seals the stater. FIG. 4 of U.S. Pat. No. 6,604,922 illustrates that the elastic layer of a liner attached to the stater has a sealing function, and this elastic layer functions as a seal member. In FIG. 13 of the same, a rotor lining made from an elastomer layer is illustrated as having a sealing function, and this elastomer layer functions as a seal member.

The measure while drilling module 168, also referred to as a drill collar, has a measure while drilling instrument not illustrated arranged in a chamber 168a provided on a wall section of a pipe having a thick wall. The measure while drilling instrument includes various sensors for measuring bottom hold data such as orientation, slope, direction of the bit, load, torque, temperature, pressure, and the like that can transmit such measured data to the surface in real time.

The logging while drilling module 170, also referred to as a drill collar, has a logging while drilling instrument not illustrated arranged in a chamber 170a provided on a wall section of a pipe having a thick wall. The logging while drilling instrument includes various sensors and can measure, for example, resistivity, porosity, acoustic wave velocity, gamma rays, and the like to acquire physical logging data and can transmit such physical logging data to the surface in real time.

The measure while drilling module 168 and the logging while drilling module 170 can use the dynamic seal member of one embodiment of the present disclosure obtained in (IV) described above within chambers 168a and 170a to protect various sensors from mud water and the like.

As illustrated in FIG. 10, the search for underground resources in the earth surface 155 using measuring devices mounted on a drill assembly includes a platform and derrick assembly 151 arranged over, for example, a borehole 156, and, for example, a bottom hole assembly (BHA) 160 as a logging tool arranged within the borehole 156 configured by a vertical hole, a lateral hole, and the like provided underground from the derrick assembly 151. The derrick assembly 151 may include, for example, a hook 151a, a rotary swivel 151b, a kelly 151c, and a rotary table 151d. The bottom hole assembly 160 is secured to the tip end of the long drill string 153 that extends, for example, from the derrick assembly 151. The mud water is fed into the drill string 153 from a pump, not illustrated, via the rotary swivel 151b and can drive the fluid drive motor of the bottom hole assembly 160. Because the bottom hole assembly 160 is fundamentally similar to the logging tool for subsea applications described in FIGS. 8 to 10, a description will be omitted here, but the dynamic seal member of one embodiment of the present disclosure can be adopted even in logging tools for underground applications. Note that the example of the bottom hole assembly 160 that included the drill bit 162, the rotary steerable system 164, the mud motor 166, of measuring while drilling module 168, and the logging while drilling module 170, was described as one embodiment, but it is not limited to this, and selections may be made in combination to match the logging tool.

Oilfield applications are not limited to the logging tool. For example, the dynamic seal member of one embodiment of the present disclosure may be applied to a down-hole tractor used in wireline logging. One example of this type of down-hole tractor is a MaxTRAC or TuffTRAC (both trademarks of Schlumberger Limited) made by Schlumberger Limited. This type of down-hole tractor can have a reciprocating seal member that has high wear resistance at a maximum temperature of approximately hundred and 175° C. for reliability over a long operating life.

Previous dynamic seal members have used a high level of polishing on the surface of the sealing piston in the down-hole tractor. Polishing the dynamic seal member in this manner has led to a high yield in piston and cylinder surfaces that have been worked to a minor surface when manufacturing. Conventional dynamic seal members made of common elastomers experience wear, leaking, reduced life of the equipment, and failure. Further, a dynamic seal member may be used at a high sliding speed of 2000 ft/hour maximum. The dynamic seal member used in the down-hole tractor may function with hydraulic oil at both ends or with hydraulic oil at one end and a fluid or mud water containing particles at the other end depending on the situation. Further, in the work of the tractor, a sliding dynamic seal member is used to function sufficiently across a sliding distance larger than a towing distance. For example, for a tractor job of 10,000 feet, the dynamic seal member is used to reliably function across an accumulated sliding distance of not more than a maximum of 20,000 feet. In addition, the dynamic seal member is generally under pressure of a maximum of 200 psi.

In contrast to this, using the dynamic seal member of one embodiment of the present disclosure in the down-hole tractor allows the above various problems to be resolved through the characteristics of the dynamic seal member described above. Particularly, the work on the surface of a piston or cylinder for tightness is eased to a lower reduction in manufacturing costs. Further, excellent wear resistance helps the seal function to have a longer life and more reliability. Furthermore, a long life becomes possible due to the low frictional properties.

Use of this type of dynamic seal member can be seen in, for example, U.S. Pat. No. 6,179,055 which is incorporated in its entirety in the present specification. More specifically, FIGS. 9A and 10A of this U.S. patent illustrate a seal member on a piston. FIGS. 9B, 10B, and 12 of this patent are similar. FIGS. 15, 12, and 16B of this patent illustrate a seal member on a piston that seals a tube and housing. Further, FIG. 16B of this U.S. patent illustrates a seal member on a rod.

Furthermore, the dynamic seal member of one embodiment of the present disclosure can be applied also to a formation testing and reservoir fluid sampling tool as an example of an oilfield application. This type of tool includes, for example, a modular formation dynamic tester (MDT is a registered trademark of Schlumberger Limited) made by Schlumberger Limited. This type of formation testing and reservoir fluid sampling tool can have a dynamic seal member having high wear resistance in the pump out module and in such other pistons. Furthermore, the formation testing and reservoir fluid sampling tool can have a dynamic seal member having high wear resistance and high temperature characteristics of a maximum of approximately 210° C. in order to seal the borehole.

Previous dynamic seal members performed multiple reciprocating actions for displacing the reservoir fluid, extracting, supplying, sampling, machinery operation, and analysis in pistons of a pump out module displacement unit. There has been a tendency for conventional piston dynamic seal members using regular dynamic seal members to stop functioning after a limited life due to wear. This problem becomes more remarkable at higher temperatures. Further, the existence of particles in the fluid accelerates the wear and damage of the dynamic seal member.

In contrast to this, using the dynamic seal member of one embodiment of the present disclosure in the formation testing and reservoir fluid sampling tool allows the above various problems to be resolved through the characteristics of the dynamic seal member described above. The dynamic seal member having high wear resistance at high temperatures can particularly improve life. The dynamic seal member having low frictional properties can reduce wear and improve life. Further, the dynamic seal member having high mechanical properties at high temperatures can improve life and reliability. In addition, the dynamic seal member having high chemical resistance can also be used exposed to fluids and oil wells at high temperatures.

Use of this type of dynamic seal member can be seen in, for example, U.S. Pat. No. 6,058,773 and U.S. Pat. No. 3,653,436 which are incorporated in their entirety in the present specification. More specifically, FIG. 2 of U.S. Pat. No. 6,058,773 illustrates a reciprocating seal member on a shuttle piston inside a displacement unit (DU) provided on the pump out module. Furthermore, FIGS. 2, 3, and 4 of U.S. Pat. No. 3,653,436 illustrate an elastomer member sealing a borehole surface lined by mud cakes.

Furthermore, the dynamic seal member of one embodiment of the present disclosure can also be applied to In situ fluid sampling bottles and In situ fluid analysis and sampling bottles as examples of oilfield applications. This type of device can be used in, for example, formation testing and reservoir fluid sampling tools and in wireline logging. These types of In situ fluid sampling bottles and In situ fluid analysis and sampling bottles can have a dynamic seal member to enable use at high pressure in low temperatures and in high temperatures. Further, these types of In situ fluid sampling bottles and In situ fluid analysis and sampling bottles can have a dynamic seal member having high chemical resistance when exposed to various produced fluids. Additionally, these types of In situ fluid sampling bottles and In situ fluid analysis and sampling bottles can have a dynamic seal member having gas resistance.

In these types of In situ fluid sampling bottles and In situ fluid analysis and sampling bottles, the reservoir fluid is recovered by reservoir conditions of sites that have high pressure and high temperature. When these bottles are recovered on the earth surface, the temperature has dropped but the pressure is still high. After recovery, the samples are transferred into other containers for storage, transport, and for analysis. During recovery of the samples, as during transport, the dynamic seal member on the sliding piston in the sample bottle fulfills a valuable function that will be described below. There have been various problems such as, for example, sample loss in deep-sea regions or the like when high pressure and low temperature sealing has not been possible during recovery until the surface, sample loss on the surface at the time of recovery, sample loss due to sealing defects that occur due to expansion because of gas absorption and chemical incompatibility with the sample, increasing friction and drag in the pistons due to dynamic seal member expansion by gas absorption, adhesion, insufficient sealing, or such other problems due to excess expansion of the dynamic seal member when transferring a sample from a bottle to another storage location or analysis device, and problems due to overlapping use of a plurality of sample bottles when working. Sample loss that occurs on the surface at the time of recovery likely leads to other types of problems especially when the sample contains substances such as H₂S, CH₄, or CO₂.

In contrast to this, use of the dynamic seal member of one embodiment of the present disclosure in In situ fluid sampling bottles and in In situ fluid analysis and sampling bottles allows the above various problems to be resolved by, in addition to the characteristics of the dynamic seal member described above, achieving excellent low temperature sealing performance while satisfying characteristics for high gas resistance, high chemical resistance, high pressure and high temperature requirements.

Use of this type of dynamic seal member can be seen in, for example, U.S. Pat. No. 6,058,773, U.S. Pat. No. 4,860,581, and U.S. Pat. No. 6,467,544 (brown et al.) which are incorporated in their entirety in the present specification. More specifically, FIG. 7 of U.S. Pat. No. 6,058,773 illustrates a seal member on a piston in a sample bottle. A configuration made up of two bottles in FIG. 2 of U.S. Pat. No. 4,860,581 illustrates a seal member on a piston in a sample bottle. FIG. 1 of U.S. Pat. No. 6,467,544 illustrates a seal valve.

Furthermore, the dynamic seal member of one embodiment of the present disclosure can also be applied to an In situ fluid analysis tool (IFA) as an example of an oilfield application. This type of In situ fluid analysis tool can have a dynamic seal member that has high wear resistance and gas resistance for down-hole PVT. PVT means analysis of pressure, volume, and temperature. Furthermore, the In situ fluid analysis tool can have a dynamic seal member that has high chemical resistance for handling the produced fluids. In addition, the In situ fluid analysis tool can have a flow line fixed dynamic seal member that has high gas resistance and high temperature characteristics of 210° C. maximum at high pressure. The flow line is the region exposed to the sampled fluid.

The In situ fluid analysis tool, in down-hole PVT, for example, has been used that a bubble point be determined with initiating gas generation by reducing pressure when recovering the reservoir fluid sample. Decompression occurs very rapidly at, for example, over 3000 psi per minute, and sudden decompression has occurred in the dynamic seal member that is directly connected to the PVT sample chamber. The dynamic seal member has been able to withstand not less than 200 PVT cycles. Further, the dynamic seal member for down-hole PVT would become unable to function due to gas on account of the sudden decompression. Therefore, with the conventional dynamic seal member available on the market, down-hole PVT could not be performed at 210° C. With the conventional dynamic seal member, blistering would occur due to defects and gas permeation due to expansion.

In contrast to this, using the dynamic seal member of one embodiment of the present disclosure in the In situ fluid analysis tool allows the above various problems to be resolved. The dynamic seal member having excellent mechanical properties at high temperature and high pressure can reduce the tendency for expansion. The dynamic seal member that has gaps reduced in the dynamic seal member by carbon nanofibers can improve gas resistance. Improving material characteristics of the dynamic seal member allows resistance to be improved against expansion and sudden decompression. The dynamic seal member having excellent chemical resistance can improve chemical resistance against commonly produced fluids.

Use of this type of dynamic seal member can be seen in, for example, US Patent Application Publication No. 2009/0078412, U.S. Pat. No. 6,758,090, U.S. Pat. No. 4,782,695, and U.S. Pat. No. 7,461,547 which are incorporated in their entirety in the present specification. More specifically, FIG. 7 of US Patent No. 2009/0078412 illustrates a seal member on a valve, and FIG. 5 illustrates a seal member on a piston seal device. FIG. 21a of U.S. Pat. No. 6,758,090 illustrates a seal member on a valve and piston. U.S. Pat. No. 4,782,695 illustrates a seal member between a needle and the PVT processing chamber. U.S. Pat. No. 7,461,547 illustrates a seal member on a valve for separating fluid in the pressure volume control unit (PVCU) as a seal member of a piston sleeve device in the PVCU for PVT analysis.

Further, the dynamics seal member of one embodiment of the present disclosure can also be applied to various devices used in, for example, wireline logging, logging while drilling, borehole testing, perforation, and sampling work as oilfield applications. These types of devices can have a dynamic seal member that can, for example, provide a high pressure seal at low temperatures and high temperatures.

These types of devices, for example when used in the deep-sea, have used dynamic seal members that function at broad temperature ranges from low temperatures to high temperatures and when the dynamic seal member stops functioning normally at low temperatures, it is likely that the device has failed or a leak has occurred into the air chamber of the electronic components or the like. Further, when sampling in deep-sea regions or in cold water regions such as the North Sea, the dynamic seal member has been used to function at a broad temperature range from low temperatures to high temperatures. This is because, in these types of water regions, although the samples are at a high temperature when retrieved from underground, the temperature of the sample carried to the surface drops to the temperature of the surface. For example, if there is an insufficient seal at high pressure and low temperature by the dynamic seal member, it is likely that there will be leakage or loss of the sample or that some other problem will occur. Many of these types of devices are filled with hydraulic oil and are pressurized between 100 and 200 psi, therefore, if a dynamic seal member that sufficiently functions at the low temperature is not used, it is likely that oil leaks will occur in cold surface conditions and problems will occur when recovering from deep-sea locations at low temperatures.

In contrast to this, use of the dynamic seal member of one embodiment the present disclosure in these types of devices can resolve the various problems described above, in addition to the characteristics of the dynamic seal member described above, by providing excellent sealing performance at high pressure and high temperature by mechanical properties that are more excellent in high temperatures and by excellent low temperature sealing properties.

Furthermore, the dynamic seal member of one embodiment of the present disclosure can also be applied to a side wall coring tool as an example of an oilfield application. This type of side wall coring tool can have, for example, a dynamic seal member that has low frictional properties and high wear resistance, a dynamic seal member that has a long life and high seal reliability, a dynamic seal member that has high temperature characteristics at a maximum temperature of approximately 200° C., or a dynamic seal member where the Delta P is not more than 100 psi (low speed sliding). Here, the Delta P is the pressure difference at both sides of the dynamic seal member of a piston, and, for example, a dynamic seal member that has low frictional properties has a smaller the Delta P, which in other words indicates that the piston can be moved at smaller pressure differences.

This type of side wall coring tool may stop coring when, for example, the dynamic seal member brings about an increase in adhesive or frictional force. Further, drilling at each core can have that the drill bit rotates and slides by engaging with the dynamic seal member while cutting geological stratum. Moreover, low sealing frictional properties has been dominant in the dynamic seal member in order to maintain high core drilling efficiency.

In contrast to this, using the dynamic seal member according to one embodiment in these types of devices allows the above various problems to be resolved through the following characteristics in addition to the characteristics of the dynamic seal member described above. The dynamic seal member having low frictional properties can reduce the amount of power consumption for core drilling work and for operation/movement. Further, the dynamic seal member having low frictional properties has a lower tendency for sticking and rolling and can improve the efficiency of core drilling work. Furthermore, the dynamic seal member having high wear resistance can improve sealing life influence having abrasive properties.

Use of this type of dynamic seal member can be seen in, for example, US Patent Publication No. 2009/0133932, U.S. Pat. No. 4,714,119, and U.S. Pat. No. 7,191,831 which are incorporated in their entirety in the present specification. More specifically, FIGS. 4 and 5 of US Patent Publication No. 2009/0133932 illustrate a seal member on a coring bit of a coring assembly driven by a motor. FIGS. 3B, 7, and 8 of U.S. Pat. No. 4,714,119 illustrate a seal member on a drill bit to mine a core from a borehole using a motor at a maximum of 2000 rpm. FIGS. 2A and 2B of U.S. Pat. No. 7,191,831 illustrate a seal member between a coring assembly and a coring bit driven by a motor, and using a low friction seal member such as the seal member of the present embodiment between the housing and the bit shown in FIG. 8B or the border of the component illustrated by reference numerals 201 to 204 in FIGS. 3 and 4 can achieve a high efficiency.

Further, the dynamic seal member of one embodiment of the present disclosure can also be applied to a telemetry and power generation tool in drilling applications as an example of oilfield applications. This type of telemetry and power generation tool can have, for example, a rotary dynamic seal member that has high wear resistance, a rotating and sliding seal member that has low frictional properties, or a dynamic seal member that has high temperature characteristics of a maximum of approximately 175° C.

This type of telemetry and power generation tool, for example, a mud pulse telemetry device such as that disclosed in U.S. Pat. No. 7,083,008, mentions that the inner portion of the tool filled with oil is protected from the borehole fluid (drilling mud water) by a rotary dynamic seal member. However, due to particles contained in the borehole fluid, there is a tendency for the dynamic seal member to wear and rupture more. Further, there is a probability that the tool will fail if mud water penetrates due to insufficient sealing on account of abrasion and wear of the dynamic seal member. Furthermore, the telemetry and power generation tool disclosed in U.S. Pat. No. 7,083,008 operates using a sliding dynamic seal member on the piston to compensate the internal oral pressure with external fluid, and there's a probability that failure of the tool will occur due to the penetration of the external fluid on account of wear, abrasion, expansion, or adhesion of the dynamic seal member.

In contrast to this, use of the dynamic seal member of one embodiment the present disclosure in a telemetry and power generation tool can resolve the various problems described above by, in addition to the characteristics of the dynamic seal member described above, improving wear resistance and low frictional properties of the dynamic seal member to obtain higher reliability for work and longer seal life.

Use of this type of dynamic seal member can be seen in, for example, U.S. Pat. No. 7,083,008 which is incorporated in its entirety in the present disclosure. More specifically, summa 2 of U.S. Pat. No. 7,083,008 illustrates dynamic seal member between rotors/a rotary dynamic seal member in a bearing assembly, and FIG. 3a illustrates a sliding dynamic seal member on a compensated piston that separates the oil and the borehole fluid (mud) in a pressure compensation chamber.

Further, the dynamic seal member of one embodiment of the present disclosure can also be applied to an inflate packer used to isolate a portion of the borehole for sampling or for stratum inspection as an example of an oilfield application. The dynamic seal member in this type of inflate packer is used to have high wear strength and high temperature characteristics in order to enable repeated expansion and contraction in a plurality of locations in the borehole.

There is a tendency for conventional dynamic seal members in packers to deteriorate and lower their sealing function because they do not have a desired high temperature characteristic. Further, the conventional dynamic seal member of a packer has a tendency to not satisfy a desired life.

In contrast to this, using the dynamic seal member of one embodiment of the present disclosure in an inflate packer allows improve life and reliability in the packer member by the dynamic seal member having more excellent wear resistance and higher high temperature characteristics.

Use of this type of dynamic seal member can be seen in, for example, U.S. Pat. No. 7,578,342, U.S. Pat. No. 4,860,581, and U.S. Pat. No. 7,392,851 which are incorporated in their entirety in the present specification. More specifically, FIGS. 1A, 1B, and 1C of U.S. Pat. No. 7,578,342 illustrates isolating a member illustrated by reference numeral 16 and sealing a blast hole by inflating a seal member. Further, in elastomer seal member (packer member) of FIG. 4A or a member illustrated by reference numerals 712 and 812 of FIGS. 7 and 8 illustrate a seal member. FIG. 1 of U.S. Pat. No. 4,860,581 illustrates an inflated packer member that seals a borehole. U.S. Pat. No. 7,392,851 illustrates an inflated packer member.

As described above, detailed descriptions were given of embodiments of the present disclosure, and a person skilled in the art will easily understand that many modifications are possible that do not depart in substance from the novelty and effect of the disclosure. Accordingly, each of these modified examples is included within the scope of the present disclosure.

Embodiments of the present disclosure will be described below, but the present disclosure is not limited to these.

(1) Sample Preparation

First Step: Introduced 100 parts per hundred rubber (phr) of a ternary fluoroelastomer shown in Tables 1 and 2 (listed as “FKM-1” and “FKM-2” in Tables 1 and 2) to an open roll (roll temperature between 10 to 20° C.) having a 6 inch diameter, and wound around the roll.

Second Step: The first carbon nanofibers (listed as “MWCNT-1” in Tables 1 and 2), the second carbon nanofibers (listed as “MWCNT-2” in Tables 1 and 2), carbon black (listed as “MT-CB” in Tables 1 and 2), peroxide as a cross-linking agent, and a compounding agent such as a processing aid, were introduced into the elastomer in the parts per hundred rubber (phr) shown in Tables 1 and 2. The roll gap at this time was set to 1.5 mm.

Third Step: After the compounding agent was introduced, the mixture containing the compounding agent was removed from the roll.

Fourth Step: the roll gap was narrowed from 1.5 mm to 0.3 mm and the mixture was introduced for tight milling. The surface velocity ratio of the two rolls at this time was 1.1. Tight milling was repeated 10 times.

Fifth Step: The roll was set to a predetermined gap (1.1 mm) and the tight-milled composite material was introduced and sheeted out to obtain an uncross-linked elastomer composition.

Sixth Step: After inserting the uncross-linked elastomer composition in an O-ring mold and press-molding (curing) for 10 minutes at 160° C., post-curing was performed for another 4 hours at 230° C. to obtain the heat resistant seal members (O-rings) used in the embodiments and comparative examples. The heat resistant seal member was an AS568B-223 O-ring.

Note that, in Tables 1 and 2, “MWCNT-1” is a multiwalled carbon nanotube (first carbon nanofibers) having a mean diameter (an arithmetic mean value were measured values of not less than 200 locations are measured using images of an electron scanning microscope) of 68 nm, “MWCNT-2” is a multiwalled carbon nanotube (second carbon nanofibers) having a mean diameter (an arithmetic mean value where measured values of not less than 200 locations are measured using images of an electron scanning microscope) of 13 nm, “FKM-1” is a ternary FKM having a Mooney viscosity ML₁₊₄121° C. (center value) 65, “FKM-2” is a ternary FKM having a Mooney viscosity ML₁₊₄121° C. (center value) 53, and “MT-CB” is carbon black having an MT grade (mean particle size and DBP oil absorption are the manufacturer published values) of 200 nm mean particle size and 25 mL/100 g DBP oil absorption amount.

Further, comparative examples 3 and 4 are samples where single one of the two types of carbon nanofibers is included; and particularly, comparative example 3 is a sample that corresponds to the seal member described in the Related Art in Patent Document 2 (International Publication WO 2011/077595).

(2) Measuring Using Pulsed NMR

Measurement for the uncross-linked elastomer composition obtained in the fifth block of the uncross linked embodiments and comparative examples was performed by a Hahn-echo method using a pulsed NMR method. This measurement was performed using a “JMN-MU 25” made by JEOL. (Ltd). The measurement conditions were with an observation nucleus of ¹H, a resonant frequency of 25 MHz, and a 90° pulse width of 2 μsec, and the decay curve was measured using a Hahn-echo method pulse sequence (90° x-Pi-180° y), and component fractions (fnn) of components having a characteristic relaxation time (T2/150° C.) and a second spin-spin relaxation time (T2nn/150° C.) were measured and composite material samples at 150° C. The uncross-linked elastomer composition samples of the embodiments are within a range of 600 to 1000 μsec, and the component fractions (fnn) of components having a second spin-spin relaxation time (T2nn) is below 0.2. Further, the uncross-linked elastomer composition samples of the comparative examples 1 and 2 exceed 1000 μsec, and the component fractions (fnn) of components having a second spin-spin relaxation time (T2nn) exceeded 0.2.

(3) Basic Characteristic Test

The rubber hardness (Hs) of the heat resistant seal member samples of the embodiments and the comparative examples were measured based on the International Rubber Hardness (IRHD) test.

Using a tensile test compliant with the ASTM 1414 test, the tensile strength (TS (MPa)), elongation at break (Eb(%)), and stress at 25% deformation (σ 25 (MPa)) were measured for the heat resistant seal members of the embodiments and the comparative examples. Further, stress at 25% deformation (σ 25 (MPa)) at 200° C. was similarly measured.

Using a dynamic viscoelasticity tester DMS6100 made by SII, Inc., a dynamic viscoelasticity test was performed on the heat resistant seal members of the embodiments and of the comparative examples at a measurement temperature between −70 and 350° C., dynamic strain of 0.05%, and frequency of 1 Hz based on JIS K6394, and the peak temperature of tan δ (Tg (° C.)) and the dynamic spring constant (K′ (kN/m)) at 200° C. were measured. The measured results are shown in Tables 1 and 2.

(4) Hydrogen Sulfide Resistance Test at 200° C.

The heat resistant seal members of the embodiment and of the comparative examples were kept in a hydrogen sulfide gas atmosphere at 200° C. for 70 hours and 160 hours based on the NACE (National Association of Corrosion Engineers) TM0296, and afterwards, a test similar to that of (3) above was performed, wherein the rubber hardness (Hs), tensile strength (Ts (MPa)), elongation to break (Eb (%)), stress at 25% deformation (σ 25 (MPa)), and the compression set (CS (%)) were measured. The compression set test was performed on the heat resistant seal member samples in compliance with ASTM D1414, and D395 after retention in a hydrogen sulfide gas atmosphere for 70 hours and 160 hours at 25% compressibility and at 200° C. The compression set is a so-called evaluation for resistance to permanent set of the heat resistant seal member in hydrogen sulfide gas at high temperature.

A specific description will be given below for the hydrogen sulfide resistance test.

In accordance with the stipulations of NACE TM0296, the following test solutions (liquid phase 1 and 2) and gas mixture (gas phase) were used in the test.

Liquid phase 1. Water: 5 vol % of the entire capacity of a high pressure container.
Liquid phase 2. Hydrocarbon liquid: 60 vol % of the entire capacity of the high pressure container.
Gas phase. Gas phase: 35 vol % of the entire capacity of a high pressure container. The gas mixture is pressurized to 1,000 psi.
Components of the carbide aqueous solution are as follows:

### Hexane: 25%

### Octane: 20%

### Decane: 50%

### Toluene: 5%

The components of the gas mixture are as follows:

### H₂S: 20%

### CO₂: 5%

### CH₄: 75%

The hydrogen sulfide (H₂S) resistance test was performed according to the following procedure.

1. The volume and mass of the heat resistant seal member sample were measured before testing and the basic characteristic test (Hs, TS, Eb, σ 25, CS) were tested according to the basic characteristic test described in (3) above.
2. The high pressure container containing the test liquid was prepared and the heat resistant seal member sample was inserted.
3. The gas mixture containing H₂S was injected into the high pressure container and kept for 70 hours (or 160 hours) at 200° C., 1,000 psi equilibrium pressure.
4. The gas mixture in the high pressure container was decompressed and released, and the heat resistant seal member sample was removed from the high pressure container.
5. The volume and mass were measured after testing and the basic characteristic test (Hs, TS, Eb, σ 25, CS) were tested according to the basic characteristic test described in (3) above.

The test results are shown in Tables 1 and 2 as “H₂S Test.” The values indicated as “A” in Tables 1 and 2 are differences between before and after testing.

TABLE 1

| | | | Embodiment | Embodiment | Embodiment | Embodiment |
|---|---|---|---|---|---|---|
| | | | 1 | 2 | 3 | 4 |
| Combination | FKM-1 | phr | 100 | — | — | — |
| | FKM-2 | phr | — | 100 | 100 | 100 |
| | MT-CB | phr | 15 | 5 | 10 | 15 |
| | MWCNT-1 | phr | 15 | 5 | 5 | 7 |
| | MWCNT-2 | phr | 10 | 10 | 15 | 15 |
| Basic | Hs (IRHD) | point | 90 | 88 | 89 | 92 |
| Characteristics | TS | MPa | 24.2 | 22.0 | 25.0 | 26.3 |
| | Eb | % | 100 | 122 | 117 | 95 |
| | σ 25 (RT) | MPa | 4.3 | 3.0 | 4.1 | 5.2 |
| | σ 25 | MPa | 3.6 | 2.4 | 3.3 | 3.7 |
| | (200° C.) | | | | | |
| | Tg | ° C. | −12.5 | −12.6 | −11.7 | −12.2 |
| | K′ (200° C.) | kN/m | 20 | 15 | 21 | 25 |
| H2S Test | Hs (IRHD) | point | 83 | 79 | 83 | 83 |
| 200° C. | TS | MPa | 14.3 | 12.8 | 14.0 | 14.5 |
| 70 hr | Eb | % | 125 | 137 | 120 | 110 |
| | σ 25 (RT) | MPa | 2.2 | 1.8 | 2.0 | 2.4 |
| | CS | % | 25 | 22 | 24 | 27 |
| | [symbol] Hs | point | −7 | −9 | −6 | −9 |
| | [symbol] TS | % | −40.9 | −41.8 | −44.0 | −44.9 |
| | [symbol] Eb | MPa | 25.0 | 12.3 | 2.6 | 15.8 |
| | [symbol] σ | % | −48.8 | −40.0 | −51.2 | −53.8 |
| | 25 (RT) | | | | | |
| H₂S Test | Hs (IRHD) | point | 83 | 81 | 83 | 83 |
| 200° C. | TS | MPa | 14.2 | 12.8 | 13.8 | 14.1 |
| 160 hr | Eb | % | 130 | 131 | 125 | 120 |
| | σ 25 (RT) | MPa | 2.2 | 2.0 | 2.2 | 2.3 |
| | CS | % | 29 | 28 | 26 | 32 |
| | [symbol] Hs | point | −7 | −7 | −6 | −9 |
| | [symbol] TS | % | −41.3 | −41.8 | −44.8 | −46.4 |
| | [symbol] Eb | MPa | 30.0 | 7.4 | 6.8 | 26.3 |
| | [symbol] σ | % | −48.8 | −33.3 | −46.3 | −55.8 |
| | 25 (RT) | | | | | |

TABLE 2

| | | | Comp. | Comp. | Comp. | Comp. |
|---|---|---|---|---|---|---|
| | | | Ex. 1 | Ex. 2 | Ex. 3 | Ex. 4 |
| Combination | FKM-1 | phr | 100 | — | 100 | 100 |
| | FKM-2 | phr | — | 100 | — | — |
| | MT-CB | phr | 80 | 80 | 55 | 25 |
| | MWCNT-1 | phr | — | — | 10 | — |
| | MWCNT-2 | phr | — | — | — | 15 |
| Basic | Hs (IRHD) | point | 93 | 93 | 90 | 94 |
| Characteristics | TS | MPa | 11.9 | 13.3 | 14.1 | 25.8 |
| | Eb | % | 90 | 76 | 81 | 120 |
| | σ 25 (RT) | MPa | 4.9 | 5.4 | 4.5 | 4.7 |
| | σ 25 | MPa | 3.1 | 3.6 | 3.8 | 3.7 |
| | (200° C.) | | | | | |
| | Tg | ° C. | −3.2 | −2.5 | −10.8 | −14.4 |
| | K′ (200° C.) | kN/m | 13 | 20 | 13 | 35 |
| H₂S Test | Hs (IRHD) | point | 81 | 80 | 83 | 82 |
| | TS | MPa | 8.5 | 9.2 | 8.9 | 14.2 |
| | Eb | % | 145 | 151 | 151 | 210 |
| | σ 25 (RT) | MPa | 1.5 | 1.7 | 1.5 | 1.6 |
| 200° C. | CS | % | 50 | 55 | 45 | 48 |
| 70 hr | [symbol] Hs | point | −12 | −13 | −7 | −12 |
| | [symbol] TS | % | −28.6 | −30.8 | −36.9 | −45.0 |
| | [symbol] Eb | MPa | 61.1 | 98.7 | 86.4 | 75.0 |
| | [symbol] σ 25 | % | −69.4 | −68.5 | −66.7 | −66.0 |
| | (RT) | | | | | |
| H₂S Test | Hs (IRHD) | point | 81 | 81 | 83 | 83 |
| 200° C. | TS | MPa | 7.0 | 7.5 | 8.6 | 13.8 |
| 160 hr | Eb | % | 160 | 149 | 140 | 215 |
| | σ 25 (RT) | MPa | 1.1 | 1.3 | 1.5 | 1.7 |
| | CS | % | 95 | 97 | 70 | 80 |
| | [symbol] Hs | point | −12 | −12 | −7 | −11 |
| | [symbol] TS | % | −41.2 | −43.6 | −39.0 | −46.5 |
| | [symbol] Eb | MPa | 77.8 | 96.1 | 72.8 | 79.2 |
| | [symbol] σ 25 | % | −77.6 | −75.9 | −66.7 | −63.8 |
| | (RT) | | | | | |

(5) High Temperature High Pressure Resistance Water Test

The compression set (CS(%)) for the heat resistant seal member of the embodiments and for the comparative examples were measured in compliance with ASTM D1414, D395 using heat resistant seal members after being held for 48 hours at 25% compressibility underwater at 200° C.

The following is a specific description of a high temperature high pressure resistance water test.

1. Measure the thickness of the heat resistant seal member was measured.
2. Interpose the heat resistant seal member between plates using screws to secure then apply a compression strain (25%).
3. Insert the heat resistant seal member and seal in the compressed state described in 2 above in a container containing water.
4. Insert the container into an oven, heat to 200° C. and keep for a predetermined time (24 hours, 48 hours, 70 hours, or 400 hours).
5. Remove the containers from the oven and wait until cooled.
6. Remove the heat resistant seal member from the container in its compressed state and heat in the oven 2 hours.
7. Remove the heat resistant seal member from the panel and release it from its compressed state, and after 30 minutes, measure the thickness.
The results of the measurements and calculations are shown in Tables 3 and 4 under “H₂O Test.” Note that tests other than 48 hours were not performed for Embodiment 1.

(6) Sudden Decompression Resistance Test

The heat resistant seal member samples of the embodiments and of the comparative examples were kept for 24 hours in a container of carbon dioxide atmosphere at 800 psi at room temperature in compliance with NACE (National Association of Corrosion Engineers) TM0297-97, and the modulus of volume change was measured for the heat resistant seal members when the pressure inside the container was rapidly decompressed to the ambient pressure in 2 seconds.

A specific description will be given below for the hydrogen sulfide resistance test.
1. Measure the volume of the heat resistant seal member sample.
2. Prepare a high pressure container and insert the heat resistant seal member sample.
3. Inject CO₂ into the high pressure container and keep at 800 psi at room temperature for 24 hours.
4. Rapidly decompressed the pressure in the high pressure container to ambient pressure in approximately 2 seconds.
5. Immediately measure the volume of the heat resistant seal member sample.
The modulus of volume change (%) in the heat resistant seal member before and after testing is shown in Tables 2 and 3 under “Anti-ED Test) as the “ΔV.”

(7) Protrusion Test

The sealable pressure was measured for the heat resistant seal member samples of the embodiments and of the comparative examples for the sealable pressure (P1 (MPa)) at 175° C. and at a clearance of 20 μm, and the sealable pressure (P2 (MPa)) at 175° C. and at a clearance of 80 μm.

A specific description will be given below for the protrusion test.
1. Two heat resistant seal member samples are attached to a jig with space therebetween.
2. The jig is attached to a pressure test system and heated in an oven at 175° C.
3. Test pressure is applied between the two heat resistant seal member samples attached to the jig and let stand for 30 min.
4. The test pressure is lowered.
5. The jig is cooled to room temperature.
6. The heat resistant seal member samples are removed from the jig, and it is verified whether they are destroyed by the protrusion.
7. If the heat resistant seal member samples are not destroyed, the test pressure of the above number three is raised and tests 1 through 7 are performed. If the heat resistant seal member samples are destroyed, the test pressure of the preceding test is designated as the sealable pressure.
The measurement results are shown under “Protrusion” for each clearance “P1” and “P2” in Tables 3 and 4.

(8) Wear Resistance Test

Physical tests were performed on the heat resistant seal member samples of the embodiments and of the comparative examples under the conditions of 175° C., 35 MPa, and 5 mm/sec in the test device illustrated in FIG. 11, and the time (T (hr)) until a leak occurred was measured. FIG. 11 is a schematic diagram for explaining the test device 210 for wear resistance testing. A piston 214 having a nearly cylindrical shape is placed in the cylindrical cylinder 212 in the oven 200, and the piston 214 can move forward and backward within the cylinder 214 by the motor 230 arranged outside the oven 200. A perimeter groove 218 is formed near the center of the forward and backward direction of the piston 214, and oil 216 is injected between the inner walls of the cylinder 212. A groove 224 to fit and O-ring on both sides of the forward and backward direction of the perimeter groove 218 is formed, and the heat resistant seal member sample 220 and a backup ring 222 are fit into the groove 224.

A specific description will be given below for the wear resistance test using FIG. 11.
1. The heat resistant seal member sample 220 is mounted on the piston 214 as illustrated in FIG. 11.
2. The test device 210, in its entirety, is heated to 175° C. inside the oven 200.
3. The pressure of the oil 216 inside the perimeter groove 218 is raised to 35 MPa.
4. The piston 214 is caused to move forward and backward by the motor 230 to perform the wear test. The travel distance at this time is 100 mm one way performed at a speed of 300 mm/min.
5. If the heat resistant seal member sample 200 is destroyed, the test is terminated.
The time until the heat resistant seal member samples are destroyed is shown in Tables 3 and 4 as “Anti-Wear Test”.

TABLE 3

| | | | Embodiment | Embodiment | Embodiment | Embodiment |
|---|---|---|---|---|---|---|
| | | | 1 | 2 | 3 | 4 |
| Combination | FKM-1 | phr | 100 | — | — | — |
| | FKM-2 | phr | — | 100 | 100 | 100 |
| | MT-CB | phr | 15 | 5 | 10 | 15 |
| | MWCNT-1 | phr | 15 | 5 | 5 | 7 |
| | MWCNT-2 | phr | 10 | 10 | 15 | 15 |
| H₂O Test | CS (24 | % | — | 51 | 53 | 52 |
| 200° C. | Hours) | | | | | |
| | CS (48 | % | 48 | 52 | 56 | 55 |
| | Hours) | | | | | |
| | CS (70 | % | — | 54 | 65 | 55 |
| | Hours) | | | | | |
| | CS (400 | % | — | 72 | 80 | 64 |
| | Hours) | | | | | |
| Anti-ED | [symbol] V | % | — | — | 4.2 | 4.8 |
| Test | | | | | | |
| Protrusion | P1 | MPa | 120 | 100 | 120 | 140 |
| | P2 | MPa | 70 | 50 | 70 | 85 |
| Anti-Wear | T | hr | 50 | 40 | 43 | 68 |
| Test | | | | | | |

TABLE 4

| | | | Comp. | Comp. | Comp. | Comp. |
|---|---|---|---|---|---|---|
| | | | Ex. 1 | Ex. 2 | Ex. 3 | Ex. 4 |
| Combination | FKM-1 | phr | 100 | — | 100 | 100 |
| | FKM-2 | phr | — | 100 | — | — |
| | MT-CB | phr | 80 | 80 | 55 | 20 |
| | MWCNT-1 | phr | — | — | 10 | — |
| | MWCNT-2 | phr | — | — | — | 15 |
| H₂O Test | CS (24 | % | 97 | 90 | 47 | — |
| 200° C. | Hours) | | | | | |
| | CS (48 | % | 98 | 90 | 54 | 68 |
| | Hours) | | | | | |
| | CS (70 | % | 99 | — | 58 | — |
| | Hours) | | | | | |
| | CS (400 | % | 100 | 93 | — | — |
| | Hours) | | | | | |
| Anti-ED | [symbol] V | % | 15.1 | 7.5 | 6.7 | 10.1 |
| Test | | | | | | |
| Protrusion | P1 | MPa | 100 | 150 | 70 | 100 |
| | P2 | MPa | 50 | 100 | 50 | 50 |
| Anti-Wear | T | hr | 7 | 30 | 23 | 10 |
| Test | | | | | | |

As seen in the results in Tables 1 and 2, the time until the heat resistant seal member samples of the embodiments to generate a leak in the wear resistant test was between 40 hours and 68 hours in conditions of 175° C., 35 MPa, and 5 mm/sec. Further, the compression set after 70 hours at 25% compressibility was not more than 40% in the under hydrogen sulfide gas atmosphere at 200° C. Further, the compression set after 48 hours at 25% compressibility was not more than 60% under water at 200° C. From this, it can be expected that the heat resistant seal member samples of the embodiments can drill for oil for a long period of time and in harsh environments previously impossible such as in a hydrogen sulfide environment. Furthermore, it can be expected that the heat resistant seal member samples of the embodiments can drill for oil for a long period of time even, for example, under water at high temperature and pressure.

Note that although there was not an example that did not combine carbon black in Embodiments 1 to 4, it was expected that the hydrogen sulfide resistance which resulted from combining the first carbon nanofibers and the second carbon nanofibers would be favorable with a slight reduction in the hardness by not combining carbon black. Further, although a comparative example was not prepared that combined 20 parts by weight each of the first carbon nanofibers and the second carbon nanofibers, it was expected that this type of sample would not have a hardness that would allow it to be used as a seal member, so this test was not performed.

### DESCRIPTION OF THE REFERENCE NUMERALS

10 First roll
20 Second roll
d Space between the first roll 10 and the second roll 20
30 Ternary fluoroelastomer
32 Bank
40 First carbon nanofibers
41 Second carbon nanofibers
42 Carbon black
50 Platform
52 Sea
54 Subsea
56 Well
60 Down-hole device
62a, 62b Pressure vessel
64a, 64b, 64c Coupling section
62a, 62b Pressure vessel
63a, 63b Electronic devices
70 O-ring
100 First cell structure
102 Second carbon nanofibers
104 Elastomer
110 Second cell structure
120 Heat resistant seal member

While only certain embodiments have been set forth, alternatives and modifications will be apparent from the above description to those skilled in the art. These and other alternatives are considered equivalents and within the scope of this disclosure and the appended claims. Although only a few example embodiments have been described in detail above, those skilled in the art will readily appreciate that many modifications are possible in the example embodiments without materially departing from the present disclosure. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A heat resistant seal member comprising:
100 parts by weight of a ternary fluoroelastomer,
5 to 15 parts by weight of first carbon nanofibers having an average diameter of not less than 60 nm and not more than 200 nm;
10 to 15 parts by weight of second carbon nanofibers having an average diameter of not less than 9 nm and not more than 20 nm; and
0 to 20 parts by weight of carbon black having an average particle size between 25 nm and 500 nm;
wherein the first carbon nanofibers and the second carbon nanofibers are both contained therein, and the total amount of the first carbon nanofibers and the second carbon nanofibers is 15 to 30 parts by weight, and the total amount of the first carbon nanofibers, the second nanofibers, and the carbon black is 20 to 45 parts by weight.

2. The heat resistant seal member according to claim 1, wherein a time until leakage occurs is not less than 40 hours and not more than 100 hours in a wear resistance test under conditions of 175° C., 35 MPa, and 5 mm/sec.

3. The heat resistant seal member according to claim 1, wherein a compression set is not more than 40% after 70 hours and 25% compressibility in a hydrogen sulfide gas atmosphere at 200° C.

4. The heat resistant seal member according claim 1,
wherein a compression set is not more than 40% after 160 hours and 25% compressibility in a hydrogen sulfide gas atmosphere at 200° C.

5. The heat resistant seal member according to claim 1,
wherein there is not more than 60% compression set after 48 hours underwater at 200° C. and 25% compressibility.

6. The heat resistant seal member according to claim 1,
wherein there is a modulus of volume change of not more than 5.0% after retaining the heat resistant seal member within a container in carbon dioxide atmosphere of 800 psi at room temperature for 24 hours and then rapidly reducing the pressure within the container to ambient pressure in 2 seconds.

7. The heat resistant seal member according to claim 1, wherein the outer external form is a continuous endless shape.

8. The heat resistant seal member according to claim 1, wherein
a lateral cross-section is a nearly circular O-ring.

9. The heat resistant seal member according to claim 1, comprising:
100 parts by weight of a ternary fluoroelastomer,
5 to 8 parts by weight of first carbon nanofibers;
12 to 15 parts by weight of second carbon nanofibers; and
10 to 15 parts by weight of carbon black;
and wherein the total amount of the first carbon nanofibers and the second carbon nanofibers is 15 to 23 parts by weight, and the total amount of the first carbon nanofibers, the second carbon nanofibers, and the carbon black is 27 to 38 parts by weight.

10. A heat resistant seal member comprising:
an elastomer,
first carbon nanofibers and second carbon nanofibers that are dispersed in the elastomer,
wherein the first carbon nanofibers form a plurality of first cell structures, and
the second carbon nanofibers form one or more second cell structures while surrounding the plurality of first cell structures.

11. A heat resistant seal member according to claim 10, further comprising carbon black.
